(19) United States
(12) Patent Application Publication
(10) Pub. No.: US 2014/0379814 A1
(43) Pub. Date: Dec. 25, 2014

(54) SYSTEM AND METHOD FOR OPTIMIZED MESSAGE CREATION AND DELIVERY

(71) Applicant: Parlant Technology, Inc., Provo, UT (US)

(72) Inventors: John Graff, Provo, UT (US); Bruce Hassler, Mapleton, UT (US); Dane Dellenbach, Pleasant Grove, UT (US); Jacob Hutchings, Provo, UT (US); Daniel B. Stovall, Provo, UT (US)

(21) Appl. No.: 13/924,372

(22) Filed: Jun. 21, 2013

(51) Int. Cl. H04L 12/58; G06F 3/0484; G06F 3/0481

(52) U.S. Cl. CPC H04L 51/12; G06F 3/04817; G06F 3/0484
USPC 709/206; 715/753; 715/835

(57) ABSTRACT

A system provides for the efficient delivery of messages from one or more message originators to one or more message recipients via a plurality of communication or messaging platforms. A message originator can create a single message and specify one or more message recipients, multiple communication platforms and delivery scheduling, all from a graphical user interface on a mobile communication device or a computer. The message will be formatted for the selected message recipients, the available and desired communication platforms in the desired priority order, and scheduled for delivery to the message recipients at selected time(s). Additionally, messages may be screened to reduce or eliminate potentially duplicate messages via one or more duplication filters. On the message recipient side, each message recipient can specify the desired communication platform and preference priority for receipt of messages, along with the desired timing for delivery of messages from each potential message originator.

### BACKGROUND OF THE INVENTION

1. Technical Field

The present invention relates generally to the field of interactive communication and more specifically relates to systems and methods for the more efficient creation and delivery of messages from a message originator to a message recipient.

2. Background Art

Most schools, businesses, government agencies, and other organizations frequently find it useful to communicate various messages to their constituencies (e.g., managers, employees, workers, students, parents, teachers, etc.). Since communication in the world today encompasses much more than simple messaging tasks such as phone calls and letters, many entities are finding it increasingly difficult to maintain the desired level of communication with the desired audience. Additionally, since the need for timely communication is increasingly important, the ability to ensure that the desired messages reach the desired recipients in a timely and efficient manner is also considered highly desirable.

Some of the main problems that hamper efforts to create an environment of effective communication and typically lead to ineffective and/or inefficient communication are driven by information overload and technology. Since there are so many available communication mediums and messaging platforms available, it may be somewhat complicated to get the desired message to the desired audience. For example, in addition to traditional “snail mail” and telephone communication, email, Skype®, Twitter®, Facebook®, Tumblr®, Instagram®, Google Chat®, Google+®, etc. are all relatively new communication methods that have been developed in recent years. Each of these communication platforms has a unique specific interface and protocol and, where there are multiple recipients for a given message, it can be time consuming and somewhat problematic to select and format the message for each possible combination of message recipients and possible communication platforms.

Additionally, even with a well-defined and limited set of communication options, most message recipients have multiple devices by which they may access the same message from a given message originator. For example, the message recipient may access a voice message on their computer or their cell phone. Similarly, a SMS text message may be accessed via a cell phone, a desktop computer, a tablet or some other mobile device. With all of these options, it can be challenging to know the best communication or messaging platforms to use for delivering each message to each recipient, particularly where the same message is to be delivered to multiple recipients.

This is particularly true because each message recipient may not only have a preferred method or preferred device for receiving messages, they may also have a scheduling preference and their preferred communication or messaging platform may vary from day to day or even vary over the course of a single day. With a larger number of potential recipients for a given message, for organizations that send the same message to multiple message recipients on a regular basis, this may make it challenging to ensure that each message recipient receives the message in a timely fashion. In order to maximize the probability of message recipients receiving the messages, many organizations will simply send the message to the message recipients via multiple messaging or communication platforms. For example, a person may receive a phone call and an email containing the same message. They may also receive a Facebook® posting or Twitter® Tweet® containing the same message. This is not only redundant, but may also irritate the message recipients as they spend time and energy sorting through the various messages received.

Further, many people are trying to reduce the amount and number of messages that are received and do not view redundant or duplicate messages as being useful. In some circumstances, the message recipient may “opt out” of further messages so as to avoid the onslaught of messages being received. Accordingly, without improvements in the current systems, procedures, and methods for the communication of messages from a message originator to a message recipient, the ability to effectively and efficiently provide important messages to the desired constituency will continue to be sub-optimal.

### BRIEF SUMMARY OF THE INVENTION

The various implementations of the present invention are provided as a computer-based system configured to allow for optimized message creation and delivery options in a multi-user, multi-organizational environment. The system provides for the efficient delivery of messages from one or more message originators to one or more message recipients via a plurality of communication or messaging platforms. A message originator can create a single message and specify one or more message recipients, multiple communication platforms (while also specifying a priority preference), and delivery scheduling, all from a graphical user interface presented via a native app on a mobile communication device or web browser interface presented via a web browser. The message will be automatically formatted for the selected message recipients, the available and desired communication platforms in the desired priority order, and scheduled for delivery to the message recipients at the selected time(s). On the message recipient side, each message recipient can specify the desired communication platform and preference priority for receipt of messages, along with the desired timing for delivery of messages from each potential message originator. Generic message sending and receiving protocols may also be established where user preferences have not been specified.

In the most preferred embodiments of the present invention, the message recipient's messaging preferences will take priority over the preferences of the message originator except for emergency or “preference override” situations or when a message recipient otherwise reports that they are not receiving messages via their preferred messaging platforms. In at least some preferred embodiments of the present invention artificial intelligence and machine learning may be used to determine which time, which day, and which messaging platform is the most preferred messaging platform and should be used to send messages to increase the probability that consumers receive the message. In this fashion, the probability of sending a message in the most efficient and speedy manner can be achieved. Additionally, the potential that a message recipient will receive and process duplicate messages may be minimized or eliminated.

Additionally, system provides a plurality of message duplicate filters to identify potential duplicate messages. By identifying potential duplicate messages, the number of duplicated messages can be reduced or eliminated, further enhancing the efficiency of the message delivery system while providing for a more user-friendly experience. A duplicate message is any message that is determined to be substantially similar to another message (“original message”) based on a comparison of the two messages.

While useful for many environments, the most preferred embodiments of the present invention are adapted for use in an educational environment to provide school administrators, teachers, parents, and students with enhanced communication capabilities.

### BRIEF DESCRIPTION OF THE FIGURES

The preferred embodiments of the present invention will hereinafter be described in conjunction with the appended drawings, wherein like designations denote like elements, and:

FIG. 1 is a schematic diagram of a computer-based system for providing optimized message creation and delivery in accordance with a preferred exemplary embodiment of the present invention;

FIG. 2 is a block diagram of a server (computer) used for implementing a computer-based system for providing optimized message creation and delivery in accordance with a preferred exemplary embodiment of the present invention;

FIG. 3 is a block diagram illustrating the interactions of end users with a computer-based system for providing optimized message creation and delivery in accordance with a preferred exemplary embodiment of the present invention;

FIG. 4 is a block diagram of a message queue for use in conjunction with a computer-based system for providing optimized message creation and delivery in accordance with a preferred exemplary embodiment of the present invention;

FIG. 4A is a block diagram of a message queue for use in conjunction with a computer-based system for providing optimized message creation and delivery in accordance with an alternative preferred exemplary embodiment of the present invention;

FIG. 5 is a block diagram of the message parameters for a message to be sent by a message originator using a computer-based system for providing optimized message creation and delivery in accordance with a preferred exemplary embodiment of the present invention;

FIG. 5A is a block diagram of message redundancy filters used for identifying duplicate messages sent by a message originator using a computer-based system for providing optimized message creation and delivery in accordance with a preferred exemplary embodiment of the present invention;

FIG. 5B is a block diagram illustrating the application of the filters used for identifying duplicate messages sent by a message originator using a computer-based system for providing optimized message creation and delivery in accordance with a preferred exemplary embodiment of the present invention;

FIG. 6 is a block diagram of the schedule and prioritization for message delivery to two recipients for receipt of messages sent by a computer-based system for providing optimized message creation and delivery in accordance with a preferred exemplary embodiment of the present invention;

FIG. 7 is a flow chart of a method for optimized message creation and delivery in accordance with a preferred exemplary embodiment of the present invention;

FIG. 8 is a flow chart of a method for setting message receipt preferences for optimized message creation and delivery in accordance with a preferred exemplary embodiment of the present invention;

FIG. 9 is a flow chart of a method for sending one or more messages in accordance with a preferred exemplary embodiment of the present invention;

FIG. 10 is a schematic representation of a user interface for creating one or more messages for transmission by a computer-based system for providing optimized message creation and delivery in accordance with a preferred exemplary embodiment of the present invention;

FIG. 11 is a schematic representation of a user interface for creating one or more messages for transmission by a computer-based system for providing optimized message creation and delivery in accordance with a preferred exemplary embodiment of the present invention;

FIG. 12 is a schematic representation of a user interface for creating one or more messages for transmission by a computer-based system for providing optimized message creation and delivery in accordance with a preferred exemplary embodiment of the present invention;

FIG. 13 is a schematic representation of a user interface for establishing user preferences for messages to be delivered by a computer-based system for optimized message creation and delivery in accordance with a preferred exemplary embodiment of the present invention;

FIG. 14 is a schematic representation of a user interface for adding message delivery platform option for a computer-based system for optimized message creation and delivery in accordance with a preferred exemplary embodiment of the present invention;

FIG. 15 is a schematic representation of a user interface for enabling or disabling message platform delivery options in conjunction with an optimized message creation and delivery in accordance with a preferred exemplary embodiment of the present invention;

FIG. 16 is a flow chart of a method for providing optimized message creation and delivery in accordance with an alternative preferred exemplary embodiment of the present invention; and

FIG. 17 is a flow chart of a method for filtering duplicate messages and providing optimized message creation and delivery in accordance with a preferred exemplary embodiment of the present invention.

### DETAILED DESCRIPTION OF THE INVENTION

The various implementations of the present invention are provided as a computer-based system configured to allow for optimized message creation and delivery options in a multi-user, multi-organizational environment. The system provides for the efficient delivery of messages from one or more message originators to one or more message recipients via a plurality of communication or messaging platforms. A message originator can create a single message and specify one or more message recipients, multiple communication platforms (including a priority preference to establish one or more preferred messaging platforms), and delivery scheduling, all from a graphical user interface on a mobile communication device or a computer. The message will be automatically formatted for the selected message recipients, the available and desired communication platforms in the desired priority order, and scheduled for delivery to the message recipients at the selected time(s). On the message recipient side, each message recipient can specify the desired communication platform and preference priority for receipt of messages, along with the desired timing for delivery of messages from each potential message originator. Generic message sending and receiving protocols may also be established where user preferences (e.g., preferred message platforms, devices, and timing) have not been specified.

Aspects of the present invention are described herein with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in or on a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Additionally, various preferred embodiments of the program product may be configured to: create and modify multiple databases; track, update and store data related to the optimized creation and delivery of messages; configure and implement various search and retrieve functions for a multitude of search requests and determinations made by users of the computer-based communication system; track and store information about various services and program features; update and transmit message to one or more end users consumers; and provide one or more user interfaces for accomplishing all of these functions.

In this fashion, the appropriate entities (i.e., business owners, managers, administrators, teachers, parents, students, etc.) can utilize the program product to initiate and complete a wide variety of database-related applications for the provision of optimized message creation and delivery services. Similarly, a program product in accordance with one or more preferred embodiments of the present invention can also be configured to perform substantially all of the steps depicted and described in conjunction with the figures below for implementing a optimized message creation and delivery system as described herein.

While the present invention will be described in detail by using various examples of a typical school or educational environment, those skilled in the art will recognize that the equipment, processes, methods and techniques described herein have broad applicability to other environments and applications where quick and efficient access to optimized message creation and delivery services is desirable.

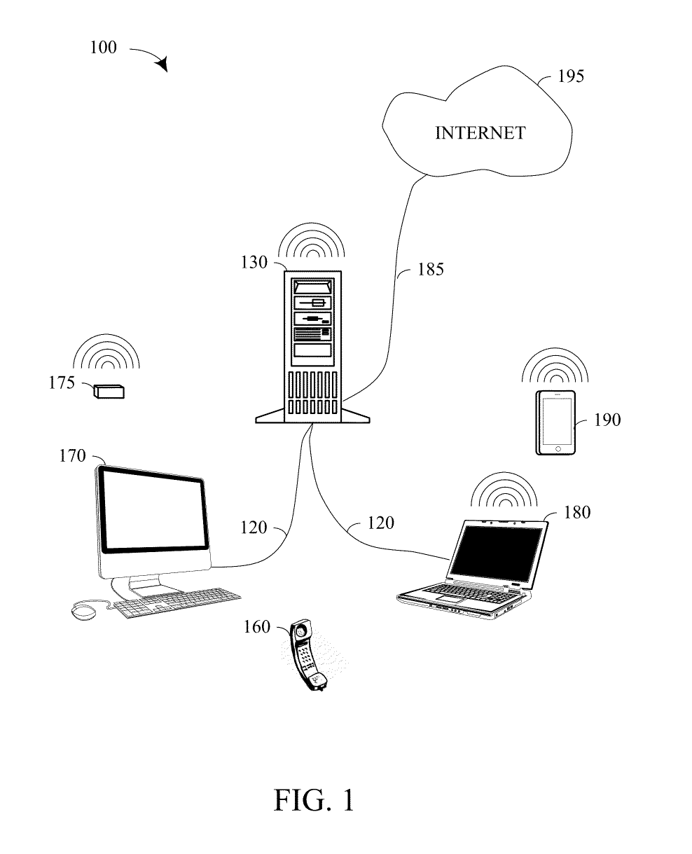

Referring now to FIG. 1, a computer-based system for providing optimized message creation and delivery 100 in accordance with a preferred exemplary embodiment of the present invention comprises: a data server (computer) 130; at least one of a desktop computer 170 or a laptop computer 180; an optional telephone 160; a wireless communication device 175; and an optional mobile communication device 190 (e.g., a smartphone or Personal Digital Assistant) all connected or coupled via a local area network 120 to the Internet 195 via an Internet connection 185.

Taken together, the components of computer-based system for providing optimized message creation and delivery 100 provide a platform for quickly and efficiently creating and delivering one or more messages to a wide variety of individuals and groups of individuals with a customized priority and delivery schedule that may be unique to each message recipient. Computer-based system 100 provides a mechanism for message originators and message recipients to efficiently and effectively create, schedule, and deliver messages across a wide range of message platforms and mediums.

In the most preferred embodiments of the present invention, computer-based system for providing optimized message creation and delivery 100 is configured as a system that will be used to disseminate messages for an educational community in a typical school environment. In this preferred embodiment, the group of users for computer-based system for providing optimized message creation and delivery 100 will typically include administrators for individual schools as well as school board and school district officials, teachers, staff, community members, parents, and students.

Network 120 represents any suitable computer communication link or similar communication mechanism, including some combination of a hardwired connection, an internal or external bus, a connection for telephone access via a modem, standard co-axial cable lines, high-speed T1 line, radio, infrared or other wireless communication methodologies (e.g., “Bluetooth,” infrared (IR), etc.), private or proprietary local area networks (LANs) and wide area networks (WANs), as well as standard computer network communications over Internet 195 or an internal network (e.g. “intranet”) via a wired or wireless connection, or any other suitable connection between computers and computer components known to those skilled in the art, whether currently known or developed in the future. It should be noted that portions of network 120 might suitably include a dial-up phone connection, a broadcast cable transmission line, a Digital Subscriber Line (DSL), an ISDN line, or similar public utility-like access link.

In the most preferred embodiments of the present invention, at least a portion of network 120 comprises a standard Internet connection 185 between at least some of the components of computer-based system for providing optimized message creation and delivery 100 for providing access to additional network resources and other remote locations. Network 120 provides for communication between the various components of computer-based system for providing optimized message creation and delivery 100 and allows for relevant information to be transmitted from device to device. In this fashion, a user of computer-based system for providing optimized message creation and delivery 100 can quickly and easily gain access to the relevant data and information utilized to search, retrieve, and display information from one or more databases as described in conjunction with the preferred embodiments of the present invention.

In the most preferred embodiments of the present invention, network 120 is configured to provide relatively high-speed transmission of textual information, audio and video data and signals, and also comprises at least an Internet connection 185 for transmission of data captured by one or more computers 170 or 180 and a phone 160 for transmission of an audio signal to and from a standard phone connection. The phone connection may be interfaced to a standard phone system typically found in most homes and commercial facilities, including for example, the existing “land line” phone system infrastructure and/or digital cellular phone communication systems.

In addition to the other components shown in FIG. 1, a wireless communication access device 175 may optionally be communicatively coupled to network 120 and represents any type of wireless communication mechanism that is known to those skilled in the art to provide for wireless communication between network 120 and the various devices associated with network 120, including desktop computer 170, laptop computer 180 and phone 160 as well as mobile communication device 190. The most preferred embodiments of an acceptable wireless communication access device may comprise any type of wireless bridge, wireless router, or wi-fi “hotspot.”

Regardless of the specific components, physical nature, and topology, network 120 serves to logically and communicatively link the physical components of computer-based system for providing optimized message creation and delivery 100, thereby enabling stable and consistent communication between the components. This is especially important because in many preferred embodiments of the present invention, data server 130, desktop computer 170, and laptop computer 180 may be geographically remote and/or physically separated from each other.

Data server 130 represents a relatively powerful computer system that is made available to desktop computer 170, laptop computer 180, and/or mobile communication device 190 via network 120. Various hardware components (not shown this FIG.) such as external monitors, keyboards, mice, tablets, hard disk drives, recordable CD-ROM/DVD drives, jukeboxes, fax servers, magnetic tapes, and other devices known to those skilled in the art may be used in conjunction with data server 130. Data server 130 may also provide various additional software components (not shown this FIG.) such as database servers, web servers, firewalls, security software, and the like. The use of these various hardware and software components is well known to those skilled in the art.

Given the relative advances in the state-of-the-art computer systems available today, it is anticipated that functions of data server 130 may be provided by many standard, readily available data servers. This may also include the deployment of multiple inter-connected and redundant data servers 130 to enhance the availability and reliability of the functions provided by data server 130. Depending on the desired size and relative power required for data server 130, storage area network (SAN) technology may also be deployed in certain preferred embodiments of the present invention. Additionally, various biometric and identification verification devices for identifying users and controlling access as well as creating and verifying digital signatures (i.e., electronic signature processing) may also be included.

Desktop computer 170 may be any type of computer system known to those skilled in the art that is capable of being configured for use with computer-based system for providing optimized message creation and delivery 100 as described herein. It should be noted that no specific operating system or hardware platform is excluded and it is anticipated that many different hardware and software platforms may be configured to create computer 170. As previously explained in conjunction with data server 130, various hardware components and software components (not shown this FIG.) known to those skilled in the art may be used in conjunction with computer 170. It should be noted that in the most preferred embodiments of the present invention, desktop computer 170 is linked (via wired or wireless connection) to its own LAN or WAN and has access to one or more additional data servers (not shown this FIG.).

In addition as shown in FIG. 1, a telephone 160 may be used in conjunction with computer 170 to allow audio messages and alerts to be communicated to telephone 160. In this embodiment, telephone 160 has been communicatively coupled to or otherwise interfaced with the standard telephone communication infrastructure associated with one or more users of computer-based system for providing optimized message creation and delivery 100. Similarly, audio messages and various other communications and alerts may be communicated to mobile communication device 190 or other personal electronic device.

Similarly, laptop computer 180 may be any type of relatively lightweight portable computer system known to those skilled in the art that is capable of being configured for use with computer-based system for providing optimized message creation and delivery 100 as described herein. This includes tablet computers (e.g., iPad®), pen-based computers and the like. Computer 180 may also be configured to allow the transmission and reception of audio signals, messages, communications, and various types of alerts via server 130 and network 120.

Additionally, netbooks, tablets, handheld and palmtop devices are also specifically included within the description of devices that may be deployed as a laptop computer 180. It should be noted that no specific operating system or hardware platform is excluded and it is anticipated that many different hardware and software platforms may be configured to create laptop computer 180. As previously explained in conjunction with data server 130, various hardware and software components (not shown this FIG.) known to those skilled in the art may be used in conjunction with laptop computer 180. It should also be noted that in the most preferred embodiments of the present invention, laptop computer 180 is linked to its own LAN or WAN and has access to its own data server (not shown this FIG.).

In general, the communication between devices associated with data server 130 will be data associated with creating and delivering messages in the most efficient and desirable manner possible, based on user preferences and priorities. The users of desktop computer 170 and/or laptop computer 180 may be program administrators, managers, teachers, community members, parents and students who are seeking to access the most relevant and valuable communication fees from the various available communication messages. Additionally, various related entities such as local and regional governments, commercial enterprises, municipalities, and their employers and agents may also have access to one or more databases located on data server 130 via desktop computer 170 and/or laptop computer 180.

It should be noted that while FIG. 1 shows only a single desktop computer 170 and a single laptop computer 180, it is anticipated that the most preferred embodiments of the present invention will comprise dozens or even hundreds of computers 170 and laptop computers 180. Each of these computers 170 and 180 will be configured to access data server 130 in an appropriately secure way so as to accomplish the specific objectives of the user of the desktop computer 170 or laptop computer 180.

For example, the service provider that controls the databases stored on data server 130 may utilize desktop computer 170 or laptop computer 180 or mobile communication device 190 to access data server 130 and create, update or otherwise modify a given database. An operator, located in a remote location, may use desktop computer 170 or laptop computer 180 to access data server 130 to retrieve information about the participants or persons and the various messages being created and delivered by the users of computer-based system for providing optimized message creation and delivery 100.

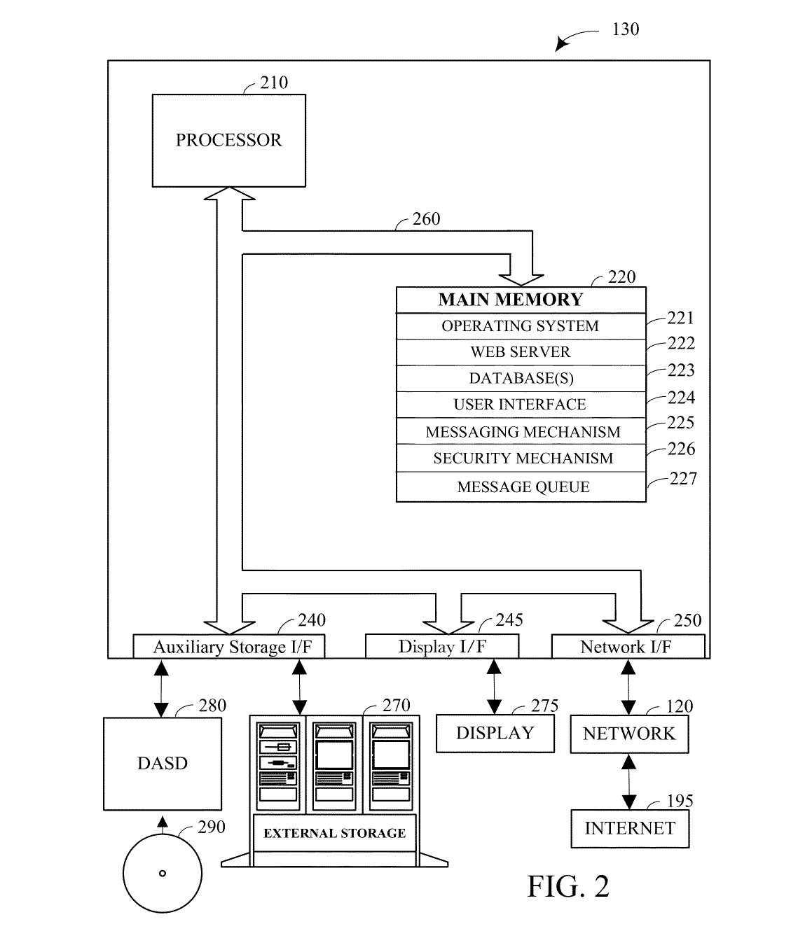

In the most preferred embodiments of the present invention, multiple desktop computers 170 and multiple laptop computers 180 will all be configured to communicate simultaneously with data server 130 and with each other via network 120. In addition, the most preferred embodiments of the present invention include a Software as a Service (SAAS) or Platform as a Service (PAAS) environment where data server 130 may be operated as a message clearinghouse in a hosted operation. In this fashion, multiple desktop computers 170 and laptop computers 180 will have access to data server 130 and the databases stored thereon via a global computer network such as Internet 195. Data server 130 is further described below in conjunction with FIG. 2 below.

An optional printer and an optional fax machine (not shown this FIG.) may also be deployed for various hard copy data output requirements and may be considered to be any standard peripheral devices used for transmitting or outputting paper-based version of messages (e.g., photographs, documents, notes, transaction details, reports, etc.) in conjunction with the various requests and transactions processed by computer-based system for providing optimized message creation and delivery 100 (e.g., reports, communications, statistical analyses, automated letters, etc.). Finally, it should be noted that the optional printer and the optional fax machine are merely representative of the many types of peripherals that may be utilized in conjunction with computer-based system for providing optimized message creation and delivery 100. It is anticipated that other similar peripheral devices will be deployed in the various preferred embodiment of the present invention and no such device is excluded by its omission in FIG. 1.

Mobile communication device 190 is representative of any type of wi-fi or Internet enabled mobile communication device or telephone that may be communicatively coupled to computer-based system for providing optimized message creation and delivery 100. This includes, for example, personal digital assistants (“PDAs”), Windows® mobile phone devices, Android® OS devices, Palm® OS devices, Pocket PC® devices, the Apple® iPod Touch®, the Apple® iPhone® and other various types of smartphones and portable communication devices. Those skilled in the art will recognize these various devices and others that are suitable for deployment as mobile communication device 190. While somewhat less powerful than computers 170 and 180, mobile communication device 190 may also be configured to wirelessly communicate with data server 130 via network 120 to send and receive messages to and from data server 130.

Given the standard functionality for devices that may be deployed as mobile communication device 190, this communication be provided by a wireless Internet connection (e.g. “wi-fi” or “wi-max”) or a Bluetooth® connection. One example of the use for mobile communication device 190 in the context of computer-based system for providing optimized message creation and delivery 100 would to send messages or alerts to a parent of a student, alerting the parent of important information regarding the educational community and surrounding activities. Additionally, by scheduling and prioritizing messages, end users can control the timing for delivery of messages to increase the likelihood of the messages being delivered to the appropriate person, at the appropriate time, via the appropriate communication platform, including a user configurable setting for specifying a time period for message delivery.

Those skilled in the art will recognize that FIG. 1 depicts a fairly standard “client/server” type communication arrangement where data server 130 is considered to be a server and computers 170 and 180 are considered to be clients of data server 130. Additionally, those skilled in the art will recognize that the functionality of data server 130 may be deployed on either of computers systems 170 and 180 in a more traditional “stand-alone” environment. In either case, the methods of the present invention are designed to minimize the amount of data that needs to be transferred from a database to the user of computer-based system for providing optimized message creation and delivery 100.

Referring now to FIG. 2, data server 130 of FIG. 1 in accordance with a preferred embodiment of the present invention represents one of many commercially available computer systems such as a Linux®-based computer system, an IBM® compatible computer system, or a Macintosh® computer system. However, those skilled in the art will appreciate that the methods and system of the present invention apply equally to any computer system, regardless of the specific operating system and regardless of whether the computer system is a more traditional “mainframe” computer, a complicated multi-user computing device or a single user device such as a personal computer or workstation.

Data server 130 suitably comprises at least one Central Processing Unit (CPU) or processor 210, an auxiliary storage interface 240, a display interface 245, and a network interface 250, all of which are interconnected via a system bus 260. Note that various modifications, additions, or deletions may be made to data server 130 illustrated in FIG. 2 within the scope of the present invention such as the addition of cache memory or other peripheral devices. FIG. 2 is not intended to be exhaustive, but is presented to simply illustrate some of the more salient features of data server 130.

Processor 210 performs computation and control functions of data server 130, and most preferably comprises a suitable central processing unit (CPU). Processor 210 may comprise a single integrated circuit, such as a microprocessor, or may comprise any suitable number of integrated circuit devices and/or circuit boards working in cooperation to accomplish the functions of a processor or CPU. Processor 210 is configured to execute one or more software programs contained within main memory 220. Although data server 130 depicted in FIG. 2 contains only a single main processor 210 and a single system bus 260, it should be understood that the present invention applies equally to computer systems having multiple processors and multiple system buses. Similarly, although system bus 260 of the preferred embodiment is a typical hardwired, multi-drop bus, any connection means that supports bi-directional communication in a computer-related environment could be used.

Auxiliary storage interface 240 allows data server 130 to store and retrieve information from auxiliary storage devices, such as external storage mechanism 270, magnetic disk drives (e.g., hard disks or floppy diskettes) or optical storage devices (e.g., CD-ROM). One suitable storage device is a direct access storage device (DASD) 280. As shown in FIG. 2, DASD 280 may be a DVD or CD-ROM drive that may read programs and data from a non-volatile DVD or CD disk 290.

Display interface 245 is used to directly connect one or more displays 275 to data server 130. Displays 275, which may be non-intelligent displays (e.g., “dumb”) terminals or fully programmable workstations, are used to provide system administrators and users the ability to communicate with data server 130. Note, however, that while display interface 245 is provided to support communication with one or more displays 275, computer data server 130 does not necessarily require a display 275, because all needed interaction with users and other processes may occur via network 120. Additionally, in certain preferred embodiments, data server 130 may have an integrated display 275.

Network interface 250 is used to connect data server 130 to network 120 and computer-based system for providing optimized message creation and delivery 100, including computer 170 and computer 180 of FIG. 1. Network interface 250 broadly represents any suitable way to interconnect electronic devices, regardless of whether the network comprises present day analog and/or digital techniques or via some networking mechanism of the future. Network interface 250 preferably includes a combination of hardware and software that allows communications on network 120.

Software provided in conjunction network interface 250 preferably includes a communication manager that manages communication with other computer systems or other network devices via network 120 using a suitable network protocol. Many different network protocols can be used to implement a network. These protocols are specialized computer programs that allow computers to communicate across a network. TCP/IP (Transmission Control Protocol/Internet Protocol) is just one example of a suitable network protocol that may be used by the communication manager contained within network interface 250.

It is important to note that while the present invention has been (and will continue to be) described in the context of a fully functional computer system with certain application software, those skilled in the art will appreciate that the various software mechanisms of the present invention are capable of being distributed as a program product in conjunction with an article of manufacture comprising software stored on a computer readable storage medium in a variety of forms, and that the various preferred embodiments of the present invention applies equally regardless of the particular type or storage medium used to actually carry out the distribution. Examples of computer readable storage media include: non-volatile and non-transitory recordable type media such as DVD and CD ROMS disks (e.g., disk 290), and transmission type media such as digital and analog communication links, including wireless communication links.

Main memory 220 suitably contains an operating system 221, a web server 222, one or more databases 223, a user interface 224, a messaging mechanism 225, a security mechanism 226, and a message queue 227. The term “memory” as used herein refers to any storage location in the virtual memory space of data server 130.

It should be understood that main memory 220 might not necessarily contain all parts of all components shown. For example, portions of operating system 221 may be loaded into an instruction cache (not shown) for processor 210 to execute, while other files may well be stored on magnetic or optical disk storage devices (not shown). In addition, although database 223 is shown to reside in the same memory location as operating system 221, it is to be understood that main memory 220 may consist of multiple disparate memory locations. It should also be noted that any and all of the individual software mechanisms or components shown in main memory 220 might be combined in various forms and distributed as a stand-alone program product. Finally, it should be noted that additional software components, not shown in this figure, might also be included.

Operating system 221 includes the software that is used to operate and control data server 130. In general, processor 210 typically executes operating system 221. Operating system 221 may be a single program or, alternatively, a collection of multiple programs that act in concert to perform the functions of an operating system. Any operating system now known to those skilled in the art or later developed may be considered for inclusion with the various preferred embodiments of the present invention.

Web server 222 may be any web server application currently known or later developed for communicating with web clients over a network such as the Internet. Examples of suitable web servers 222 include Apache web servers, Linux web servers, and the like. Additionally, other vendors have developed or will develop web servers that will be suitable for use with the various preferred embodiments of the present invention. Finally, while depicted as a single device, in certain preferred embodiments of the present invention web server 222 may be implemented as a cluster of multiple web servers, with separate and possibly redundant hardware (e.g., load balancers) and software systems. This configuration provides additional robustness for system uptime and reliability purposes. Regardless of the specific form of implementation, Web server 222 provides access, including a user interface, to allow individuals and entities to interact with graphical user interface 224, including via network 120 of FIG. 1.

Database 223 is representative of any suitable database known to those skilled in the art. In the most preferred embodiments of the present invention, database 223 is a Structured Query Language (SQL) compatible database file capable of storing information relative to various items that may be of interest to the users of computer-based system for providing optimized message creation and delivery 100 of FIG. 1. In the most preferred embodiments of the present invention, database 223 will comprise a plurality of information that may be useful to an organization or individual that wants to provide communication messages for consumption by one or more message recipients, in conjunction with a preferred embodiment of computer-based system for providing optimized message creation and delivery 100 of FIG. 1.

Graphical user interface 224 is a software component that provides the users of computer-based system for providing optimized message creation and delivery 100 of FIG. 1 a means for interacting with the various components of computer-based system for providing optimized message creation and delivery. In at least some of the most preferred embodiments of the present invention, graphical user interface 224 is a web browser based interface, accessible to the users of computer-based system for providing optimized message creation and delivery services via any standard web browser from any computer that is connected to the Internet. Additional details on graphical user interface 224 are presented below.

Additionally, at least one preferred embodiment of the present invention comprises a graphical user interface deployed on a mobile communication device 190. In this embodiment, a graphical user interface may be offered via an “app” customized for mobile communication device 190 or via a web browser based interface provide via a connection to data server 130, allowing the user of mobile communication device 190 to access messaging mechanism 225 and database 223. In either case, the consumer of the aggregated communication messages provided by data server 130 will be accessible and customizable via the graphical user interface provided in conjunction with mobile communication device 190.

In at least one preferred embodiment of the present invention for optimized message creation and delivery in an educational environment, database 223 of FIG. 2 will typically include a plurality of database records containing information about multiple schools and students (e.g., school location, student names, grades, dates and times of attendance, etc.) as well as information about teachers and parents (e.g., names and addresses, contact information, employment information, family information, etc.), and entries which are defined as specific situation/circumstances for various performance and event applications (e.g., club, sports, or other extracurricular participation data for identifying relevant messages for a student or group of students) as well as information providing for tracking, analyzing and reporting information about message originators, message recipients, the number and quantity of messages created and sent. This information may be provided to interested and authorized users of computer-based system for providing optimized message creation and delivery 100 of FIG. 1.

Database 223 will also store user profiles (e.g., message originator profiles, message recipient profiles, organization profiles, etc.) containing detailed information about each user or group of users, including user communication preferences, phone numbers, email addresses, message delivery preferences, schedules, and prioritization, permissions, home and work addresses, etc. In this fashion, a message originator with access to database 223 will be provided with the capability of quickly and easily creating multiple messages for delivery to one or more message recipients.

In at least one preferred embodiment of the present invention, teachers and staff members can add relevant information to database 223 of FIG. 2 in order to enhance the efficiency of the messages being sent by the users of system 100. For example, District or school administrators will be able to specify or limit message delivery options to approved message recipients, approved communication platforms and approved message delivery times for the delivery of messages via system 100, thereby limiting the available options to those that are in compliance with the school or district communication policies. Within these parameters, teachers will be allowed to create specialized messages for their class or students and/or their parents and guardians. Similarly, coaches for the student athletes attending the school will be able to create specialized messages for their sport or team. This will allow for more highly customized messages, based on the availability of the messaging options.

Those skilled in the art will recognize that other types of information for other types of data that may be used in other applications (e.g., historical, informational, technical, etc.) may be stored and retrieved as well. While database 223 is shown to be residing in main memory 220, it should be noted that database 223 might also be physically stored in a location other than main memory 220. For example, database 223 may be stored on external storage device 270 or DASD 280 and coupled to data server 130 via auxiliary storage I/F 240. Additionally, while shown as a single database 223, those skilled in the art will recognize the database 223 may actually comprise a series of related databases, logically linked together. Depending on the specific application and design parameters, database 223 may take many different forms when implemented.

The most preferred embodiments of computer-based system for providing optimized message creation and delivery 100 of FIG. 1 will include a messaging mechanism 225 in main memory 220. Messaging mechanism 225 will generally comprise a series of task oriented (e.g., message assembly, message scheduling, etc.) routines. Messaging mechanism 225 is an automated programmable system that is capable of assisting message originators and message recipients with the various tasks associated with generating one or more messages or message events, by gathering, monitoring and using the information stored in database 223 by users of system 100. In the most preferred embodiments of the present invention, messaging mechanism 225 will be configured to manage and coordinate the delivery of messages from message originators to message recipients via message queue 227. This includes email messages, tweets, audio and video data, RSS fees, and/or SMS text messages to message recipient's computers, telephones, cell phones or other mobile communication devices such as mobile communication device 190 of FIG. 1. Messaging mechanism 225 may also be used to generate hard copy messages (e.g., mail merge letters, greeting cards, memos, etc.) that are then sent via standard U.S. Postal Service or some type of commercial message delivery company.

Although multiple delivery options will be provided to the message originator, in the most preferred embodiments of the present invention, messaging mechanism 225 is configured to provide optimized message creation and delivery messages based on the preferences of the message recipient. Each message recipient, as an authorized user of computer-based system 100, will have an account and their account information will be stored in database 223 of FIG. 2. It should be noted that the output from messaging mechanism 225 might be determined based on preferences maintained in conjunction with each message recipient's account. Each message recipient may specify their preference for message and content delivery preferences via user interface 224.

For example, if a message recipient prefers to receive a message via email, then messaging mechanism 225 will store the message in message queue 227 for delivery to the message recipient via email. Alternatively, a visually impaired person may request their messages in an audio format. By using various text to speech conversion technologies, their messages will be converted to an audio signal and delivered via telephone 160 of FIG. 1 or as an audio stream delivered via an application on mobile communication device 190 of FIG. 1 or as an audio file attached to an email.

In other situations, a message comprising a combination of audio, video, textual and other formats may be delivered to a message recipient. Additionally, each message recipient will be able to specify which types of devices are available to the message recipient and the most preferred delivery methodologies, priorities, and times for message delivery via various communication platforms. The message recipient can select the desired communication or message platform and set a prioritization schedule for message delivery to one or more devices. Additionally, if a message originator selects multiple delivery options, one or more of the specified options may not be available to all intended message recipients and messaging mechanism 225 will select an available option for delivery. For example, if a message contains material that is incompatible with the message recipient's available devices (e.g., a multi-media file in a message delivered to a feature phone), the incompatible content may be excluded from the message or an alternative device may be selected from the group of available devices associated with the message recipient's profile contained in database 223.

Messaging mechanism 225 can also send push notifications to third party servers, such as the Apple Push Notification Service or Google Cloud Messaging for Android, which then deliver push notifications to smart phones using server-push technology in which a communication between a computerized message delivery service and a user alert is initiated by the message delivery service rather than the user. This will alert the message recipient that a new message is waiting.

Messages may also be translated from one language into another so that message recipients can view the message in a language other than the default language. For example, messaging mechanism 225 retrieves the language setting of the message recipient's mobile device through an HTTP request header and uses the language of the language setting as the target language, or if the message recipient has selected a language within the settings of their user profile in database 223, then messaging mechanism 225 uses the language which the message recipient selected in the user profile as the target language instead of the language setting of the message recipient's mobile device.

When a message recipient is to receive a message with textual content, messaging mechanism 225 determines whether the message recipient has selected a target language other than the default language, and if so, then messaging mechanism 225 sends a to query database 223 to determine if the requested content has already been translated and stored in database 223. If the response to the query is that the requested content has not been translated and stored in database 223, messaging mechanism 225 then sends a request to a translation service, such as the Google® Translate service or the Bing® Translator service.

In the most preferred embodiments of the present invention, a translation request is sent via HTTP. In the request, messaging mechanism 225 sends to the translation service the following information: the content, which is supposed to be translated, the source language, and the target language. In the most preferred embodiments, each entry is associated with an entry unique identifier and each language is associated with a unique language identifier. When messaging mechanism 225 receives the translated content from the translation service, then messaging mechanism 225 includes the translated content in the message sent to the message recipient. In at least some preferred embodiments of the present invention, computer-based system 100 performs ad hoc translation of messages at the time of message delivery. Each message recipient may select a primary and secondary language for message delivery.

In at least one preferred embodiment of the present invention, messaging mechanism 225 also saves the translated content in database 223 by associating the newly translated content with a unique identifier and a corresponding language unique identifier so that messaging mechanism 225 can more quickly retrieve the translated content from database 223 in the future so that if a subsequent requests for translation of the content in target language, where the content has already been translated and saved to database 223, the previously translated content can be simply retrieved and included in the message.

In the most preferred embodiments of the present invention, the default source language for all messages is English. However, for certain applications the source language could be another language such as Spanish. Message recipients who understood both Spanish and English may prefer to view a message in the source language, such as English, if they believed the translation of the entry into a target language, such as Spanish, was sub-optimal. In some embodiments, user interface 224 displays an icon or other indicator that can be selected by the message recipient to display the received message in the original source language instead of the target language.

In some preferred embodiments of the present invention, computer-based system 100 uses an application program interface (“API”) to request information from and send information to third party service providers. This allows messaging mechanism 225 to access services such as LinkedIn®, Facebook®, and Twitter® to deliver messages to the user accounts for message recipients that have selected these communication platforms.

Additionally, messaging mechanism 225 and message queue 227 may be configured to generate a facsimile message by utilizing a fax server and a facsimile modem (not shown this FIG.) that is deployed in conjunction with data server 130 of FIG. 2. Messaging mechanism 225 is also capable of being configured and used to send and receive various electronic status messages (e.g. audio and video alerts) and updates to data server 130 and between computers 170, 180, and/or mobile communication device 190 of FIG. 1, as may be necessary to enhance the overall process of completing activities related to the provision of optimized message creation and delivery services as described herein.

In the most preferred embodiments of the present invention, messaging mechanism 225 is configured to generate and transmit a plurality of messages with each message containing multiple discrete elements. For example, each message may contain text, PDF and .JPG attachments, audio-video segments, audio clips generated by an automated text-to-speech computer program, contemporaneously recorded audio clips that are unique to a specific message, etc. Additionally, dynamic audio clips, using elements extracted from database 223, that are associated with a specific individual, may also be used for optimized message creation and delivery. For example, a generic introduction or greeting from the supervisor or teacher associated with a specific individual may be included, a facility identifier (e.g., school, factory, or office building location associated with the at least one individual), as well as the purpose for inclusion of the specific content in the message (e.g. expression of concern, encouraging message, etc.).

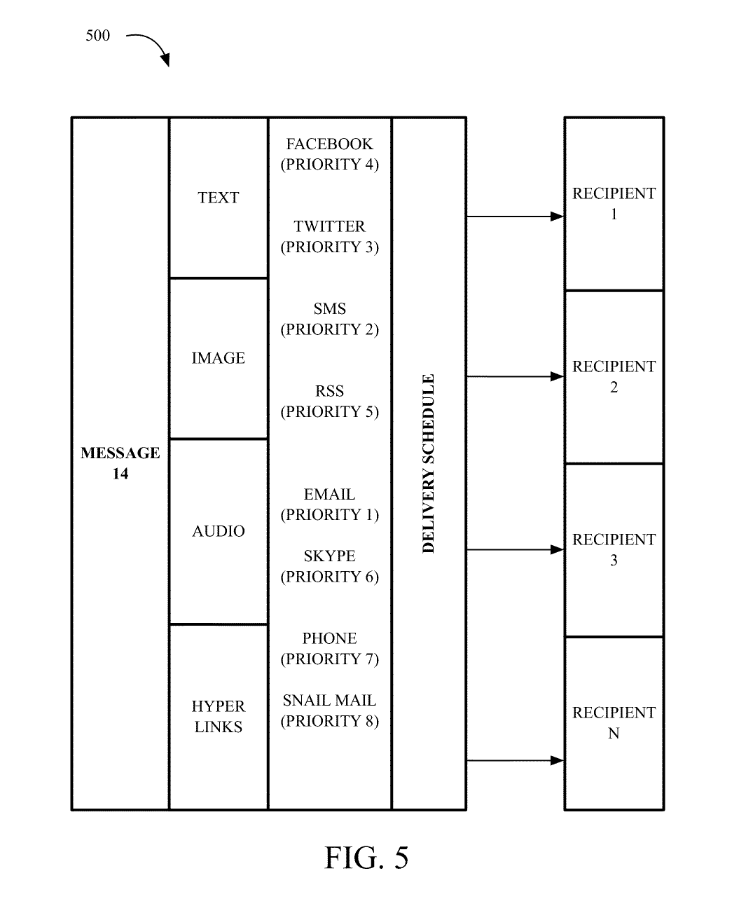

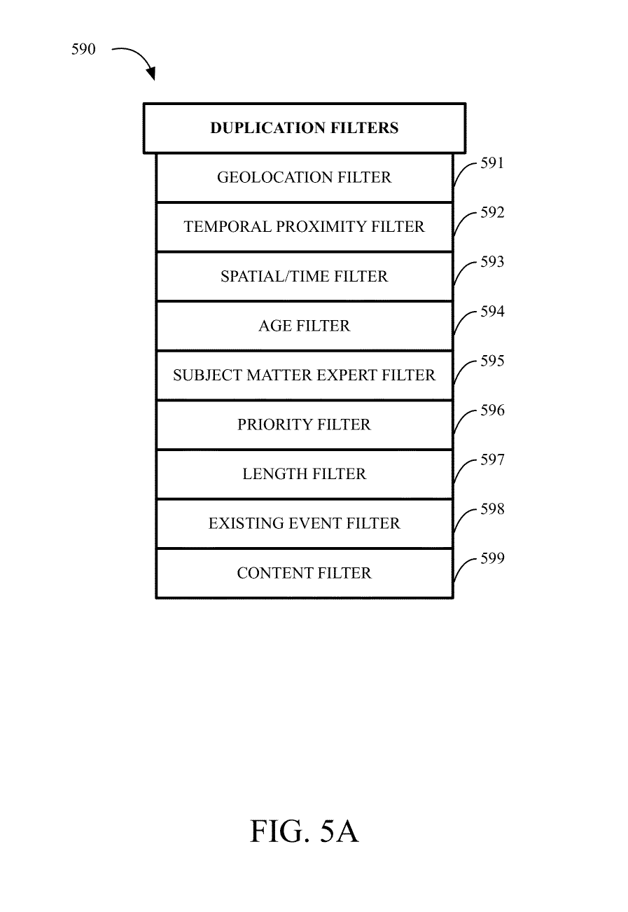

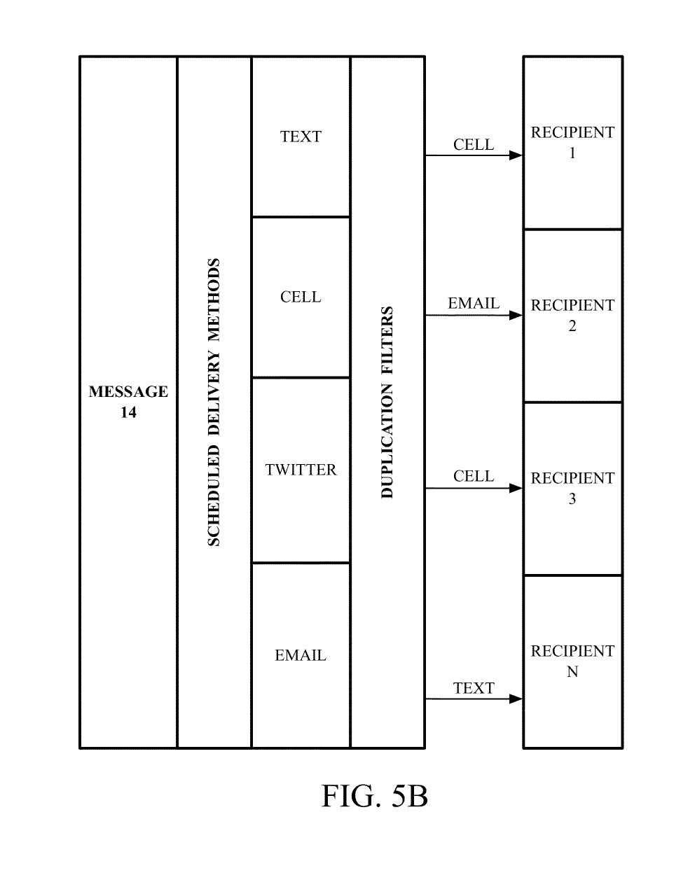

Further, in the most preferred embodiments of the present invention, messaging mechanism 225 will most preferably be configured with one or more message duplication filters that will provide for the reduction or elimination of duplicate messages. Additional information about duplicate message filters is provided below in conjunction with FIG. 5A.

In addition, the most preferred embodiments of the present invention comprise security mechanism 226 for verifying access to the data and information contained in and transmitted to and from data server 130. Security mechanism 226 may be incorporated into operating system 221 and/or web server 222. Additionally, security mechanism 226 may also provide encryption capabilities for other components of computer-based system for providing optimized message creation and delivery 100 of FIG. 1, thereby enhancing the robustness of computer-based system for providing optimized message creation and delivery 100 of FIG. 1. Security mechanism 226 is most preferably configured to protect the integrity and security of the information and messages transmitted via network 120 of FIG. 1.

Further, depending on the type and quantity of information stored in database 223 and accessed by graphical user interface 224, security mechanism 226 may provide different levels of security and/or encryption for different computer systems 170 and 180 of FIG. 1 and the information stored in database 223. The level and type of security measures applied by security mechanism 226 may be determined by the identity of the message recipient and/or the nature of a given request and/or response. In some preferred embodiments of the present invention, security mechanism 226 may be contained in or implemented in conjunction with certain hardware components (not shown this FIG.) such as hardware-based firewalls, switches, dongles, and the like.

Message queue 227 is a specialized memory location that is configured to store messages for delivery to the specified message recipients, at a pre-determined time. Messages will be placed into message queue 227 by messaging mechanism 225. Since the creation of a message to be delivered at a later time by a message originator is a common feature of system 100, the order in which the messages were created or stored in database 223 will not always match the delivery schedule as determined by messaging mechanism 225.

In the most preferred embodiments of the present invention, the various components of computer-based system for providing optimized message creation and delivery 100 of FIG. 1 are able to communicate using multiple communications protocols and systems (e.g., Voice over IP or “VoIP”, email, SMS, RSS, Plain Old Telephone Service or “POTS”, etc.). Those skilled in the art will recognize that the communication protocols used herein may be readily adapted and configured to allow for the rapid and efficient transmission and receipt of message by and between the various components of computer-based system for providing optimized message creation and delivery. This would also include the ability to control and customize the input and output of computer-based system for providing optimized message creation and delivery for integration with other systems. While a specific exemplary embodiment of a suitable server 130 has been provided above, those skilled in the art will recognize that many other suitable computers (with more or fewer features) may be substituted for the specific example provided herein within departing from the spirit and scope of the present invention.

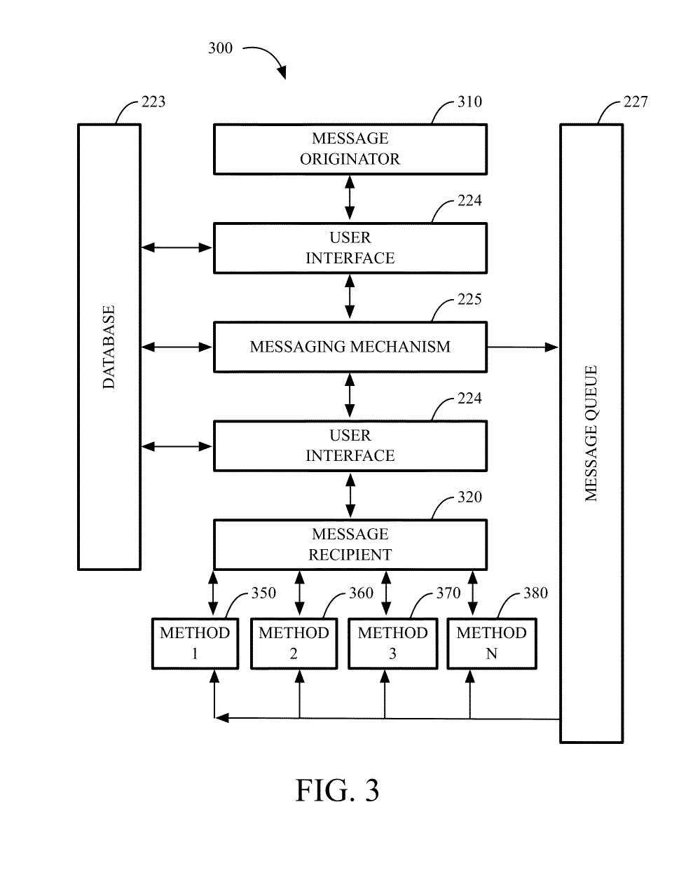

Referring now to FIG. 3, a block diagram 300 depicting the interactions for users with computer-based system for providing optimized message creation and delivery 100 of FIG. 1 is depicted. As shown in FIG. 3, a message originator 310 will interact with user interface 224. By accessing user interface 224, message originator 310 can input and modify the data contained in database(s) 223, including accessing database 223 to create and send messages to message recipient 320. As previously explained, user interface 224 is configured to programmatically interact with messaging mechanism 225 and database 223 of FIG. 2, specifically for the purpose of processing the information necessary to transmit messages between message originator 310 and message recipient 320.

Similarly, message recipient 320 will interact with messaging mechanism 225 and database 223 via user interface 224. It is important to note that message originator 310 and message recipient 320 are both likely to switch roles during the communication process. For example, upon receiving a message from message originator 310, message recipient 320 may determine to prepare and send a response to message originator 310. In that case, message recipient 320 becomes the “message originator” and message originator 310 becomes the “message recipient.”

Additionally, message recipient 320 may have multiple devices that have been configured to receive messages from message originator 310. Message originator 310, in order to ensure that message recipient 320 receives the messages, may opt to configure a message to be sent via multiple communication methods, to multiple communication methods such as method 350, method 360, method 370, and method 380. Each of method 350, method 360, method 370, and method 380 comprises a communication platform and associated device. For example, method 350 may comprise a message from message originator 310 that is delivered to a cell phone via a social networking platform using wi-fi. Method 360 may comprise a message from message originator 310 delivered to a cell phone via SMS. Method 370 may comprise an email message from message originator 310 delivered to a computer via the Internet. In the most preferred embodiments of the present invention, one or more redundancy filters will be applied to ensure that the delivery of duplicate messages is reduced or eliminated to the extent possible.

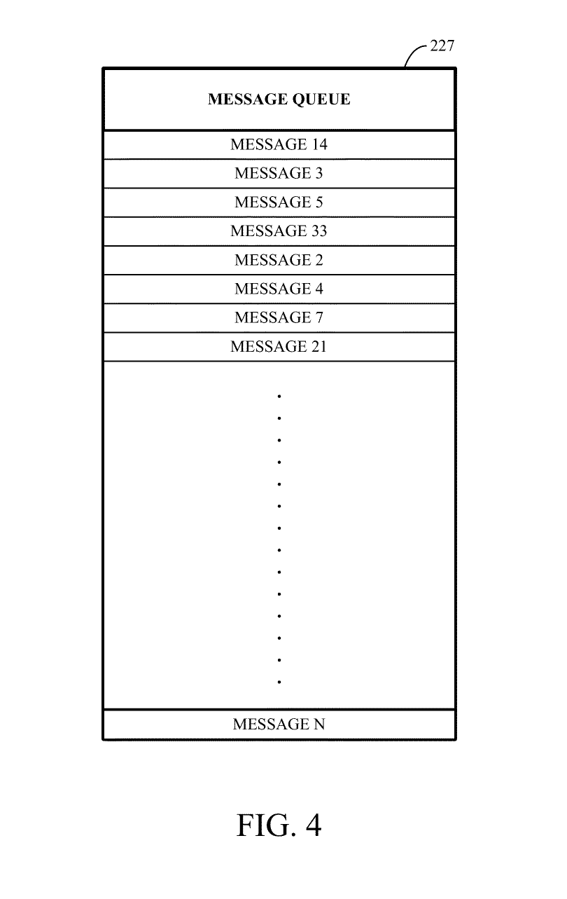

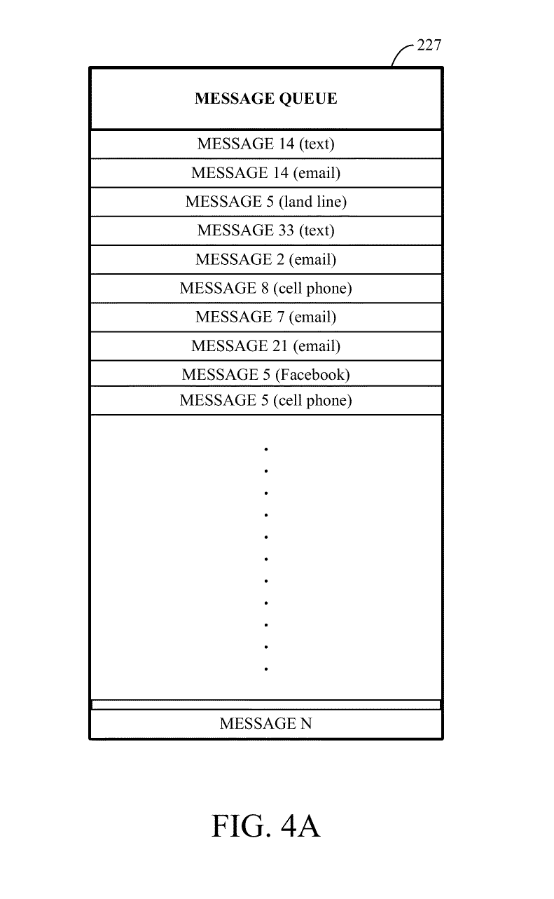

Referring now to FIG. 4, a block diagram of a plurality of messages stored in message queue 227 is depicted. As shown in FIG. 4, the messages are not necessarily stored in message queue 227 in the order in which they were created. Instead, message queue 227 is a dynamic message queue and the messages are typically positioned in the queue in the order in which they are to be sent to the selected message recipients. The exact timing for delivery of each message in message queue 227 will be determined by using the time specified by the message originator for delivery of the message.

It is important to note that a “delivery window” will be established by computer-based system for providing optimized message creation and delivery 100 of FIG. 1. System 100 will store messages in message queue 227 and the time specified for delivery by the message originator will serve as the baseline for delivery. However, depending on a variety of factors, including the number of recipients, message or communication platform specified for delivery, etc., the actual delivery time may be programmatically adjusted by messaging mechanism 225 of FIG. 2. It is also important to note that while the message originator creates a single message and a delivery time for the message, the message originator may specify a different delivery time for each message recipient, depending on the message originator's preferences. Similarly, even with the same specified delivery time for multiple message recipients, each message recipient may receive their message at a different time, depending on their message receipt preferences.

Referring now to FIG. 4A, message queue 227 depicts the presence of multiple duplicate messages prior to processing in accordance with a preferred embodiment of the present invention. Message 14 is scheduled to be sent as a text message and as an email message. Message 5 is scheduled to be sent as a phone call to a landline, a Facebook® post, and as a phone call or message to a cell phone. In at least some cases, the multiple versions of the duplicate message may end up being sent to a person via all message platforms, leading to the delivery of duplicate messages.

Referring now to FIG. 5, a block diagram 500 representing the various types of information associated with a message created by a message originator is depicted. As shown in FIG. 5, message 14 includes textual elements, graphic or image elements, audio elements, and hyperlinks to various types of content accessible via the Internet. In addition, in certain preferred embodiments of the present invention, the message originator may specify a desired order for delivery of message 14 to four message recipients. In this example, the message originator has specified eight different communication or message delivery options, and prioritized the various options.

In this example, the message originator has also indicated a delivery schedule. As previously noted, “message recipient” may refer to a single individual (e.g., “John Smith” or to a group of individuals (e.g., “Parents of Soccer Team Player”). User interface 224 of FIG. 2 can be used to specify the exact identity of the intended message recipient(s). Similarly, the user interface associated with mobile communication device 190 may be utilized to create and send messages, including selecting the desired message recipient(s).

With this information, messaging mechanism 225 of FIG. 2 can programmatically devise a “best match” or “best fit” message delivery scenario by comparing the message receipt preferences of each message recipient and matching the message originator's delivery preferences and each message recipient's message receipt preferences. In other situations, the message originator may simply send a message without including any delivery preferences and the message recipient's message receipt preferences will be the only factor considered and each message recipient will receive message 14 accordingly.

Referring now to FIG. 5A, a plurality of available redundancy filters 590 are included in messaging mechanism 225 of FIG. 2. As shown in FIG. 5A, available filters include a geolocation filter 591, a temporal proximity filter 592, a spatial/time filter 593, an age filter 594, a subject matter expert filter 595, a priority filter 596, a length filter 597, an existing event filter 598, and a content filter 599.

In conjunction with the application of one or more duplication filters 590, it is necessary to identify duplicate messages or potentially duplicate messages. Filters 590 can be used to identify potentially duplicate messages and then prevent the duplicate messages from being delivered. As previously noted, system 100 allows the operator or administrator of the system to override message recipient preferences in certain cases such as emergencies. It may be desirable to send duplicate messages to one or more message recipients in certain situations and the most preferred embodiments of the present invention allow for such contingencies.

There are a number of ways for system 100 to programmatically identify potential duplicate messages. For example, three common scenarios can be used to illustrate the types of duplication that may occur.

Scenario A (Slight Variation in Wording)
First message—“School will be canceled tomorrow.”
Second message—“School has been canceled tomorrow.”

Scenario B (Differences in Words/Length of Message)
First message—“The chess tournament begins at 6:00 PM on Saturday, June 30 in the gymnasium.”
Second message—“Chess tournament begins at 6 PM on Sat., June 30 in the gym.”

Scenario C (Similar Words/Abbreviations)
First message—“The chess tournament is canceled tonight but begins at 6:00 PM on Saturday, June 30 in the gymnasium.”
Second message—“The chess tourney is canceled tonite but begins in the gym at 6 PM 6/30.”

In Scenario A, system 100 would identify the messages as being duplicates based on the significant similarity in all of the relevant words.

In Scenario B, the first message has 77 characters and the second message has 60 characters with 85.7% of the characters matching. Given a confidence interval or threshold of 85%, and with the characters being in the same relative position in both messages, system 100 would determine that the two messages were duplicates.

In scenario C, system 100 would identify the messages as being duplicate messages based on the similarity of the date, the time, and the location of the event. System 100 would also identify common abbreviations and word substitutions (e.g., “tourney” for “tournament” “tonight and “tonite” and “gym” for gymnasium”).

In at least one preferred embodiment of the present invention, system 100 will be configured to compare the titles of two different messages and use the similarity of the title as a starting point for detecting duplicate messages. In another preferred embodiment of the present invention, system 100 is configured to identify duplicate messages by examining the first or last 100 characters of multiple messages, looking for a predetermined number of first characters that match between the messages (e.g., comparing the first 20 characters) and use fuzzy logic where at least 90% or some other user configurable threshold are the same characters in the same position are identical.

Similarly, system 100 can monitor usage patterns exhibited by the message originator when composing the message. If the message originator is using a mobile application, and the content from an email is copied and pasted to upload to a social media platform, then the content of the two messages will be substantially the same and the messages can be marked as duplicates. In some embodiments, system 100 will not suppress duplicate messages unless the message originator sends the message out to two or more platforms. For example, if system 100 determines that a school or organization is sending the same message with substantially the same content and the administrator has sent that message to two or more platforms such as to email and to Facebook, then system 100 can be configured to assume that the messages which were sent to the message recipient were duplicate messages.

Alternatively, when a message originator attempts to transmit a message that is a probable duplicate of a previously transmitted message, then system 100 performs analysis and alerts the message originator that it appears that they are trying to transmit a duplicate message. The message originator will be able to confirm that they really want to transmit a duplicate message. If the administrator presses the confirmation button then the system will send out the duplicate message. The system may delete the duplicate communication but in some embodiments the system does not delete the duplicate message but suppresses the duplicate message so that it is not visible to the message recipient. For example, if a message recipient has followed or is following an organization from an app on a mobile device and is capable of receiving both Facebook® and Twitter® posts through the app, the system will post to only one of the accounts based on a default hierarchy or a user configurable hierarchy. Those skilled in the art will understand that these and other methodologies may be combined in various ways to accurately and efficiently identify duplicate messages.

Preliminarily, if a duplicate message is scheduled to be sent out and neither the message originator nor the message recipient has enabled the system to send duplicate messages, then the default system behavior will be to identify and eliminate the duplicate messages. However, if a message originator wants to send a message via Facebook® and via Twitter®, and if the message recipient has activated their profile settings to enable duplicate messages, then system 100 will send duplicate messages to that message recipient. The underlying concept is that the message originators and the message recipients should have the ability to determine the most appropriate messaging configuration for their specific needs.

Geolocation filter 591 provides for screening of potential duplicate messages based on physical proximity relationships (e.g., the physical location of multiple devices or multiple people). If multiple messages have been identified as duplicate messages, computer-based system 100 can use geolocation information to eliminate one or more duplicate messages based on physical location. If the messages are to be sent to a message recipient's cell phone (via text message) and home computer (via email) the system 100 can check the physical location of the cell phone (via GPS or other location technology) and access database 223 of FIG. 2 to determine if the cell phone is located in close proximity to the message recipient's home address. If so, then system 100 will eliminate one of the duplicate messages from message queue 227.

System 100 can also eliminate duplicate messages based on geolocation for multiple devices, such as an iPad® and an iPhone®. If both devices are in the same physical location, then a duplicate message may be sent to only a single device. Alternatively if sent to both devices, once the user reviews the message on the first device, the message can be eliminated from the second device. Similarly, if a student's parents are in close physical proximity, then system 100 can eliminate a duplicate message being sent to one of the parents based on the physical proximity of their cell phones, for example. The exact distance for invoking geolocation filter 591 can be determined by a specified user configurable distance.

Similarly, if the physical location of the message recipient's cell phone is in close physical proximity to the message recipient's work phone (as determined by the user profile information from database 223 of FIG. 2), then only a single phone call would be made, eliminating the second phone call from being made.

Temporal proximity filter 592, allows for suppressing duplicate messages based on the time that the messages were sent. If duplicate messages are being sent at approximately the same time but being sent via different messaging platforms, system 100 can suppress one or more of the duplicate messages. User preferences can establish the time frame for duplicate messages to account for lag and latency times associated with message creation and queuing.

Spatial/time filter 593 provides a way to override or alter message delivery for eliminating duplicate messages (e.g., identical or nearly identical messages) that are separated by a certain period of time. For example, if a football game tweet is sent out three days before the football game and then re-tweeted day of the game, system 100 would generally regard this as a duplicate message and suppress the second message. However, some message recipients may wish to receive the reminder message, even if it is a duplicate of a previously received message. Each message recipient can configure their preferences to allow them to receive duplicate messages if the duplicate messages are separated in time by a user configurable number of days or hours.

Age filter 594 provides a filter for duplicate messages based on the age of the recipients. For example, if a duplicate message is being sent to multiple members of the same household (e.g., a parent and their child) then the age filter can be used to screen duplicate messages based on the age of the message recipient. In this case, the parent may configure their preferences so that duplicate messages are not sent to anyone in the household under the age of 18. This will prevent the duplicate messages from being sent to their 14-year-old student.

Subject matter expert filter 595 provides for filtering of duplicate messages based on user configurable designations regarding the subject matter of each message and a pre-identified level of knowledge for a plurality of intended message recipients. For example, if a husband and wife are both scheduled to receive the same message, system 100 can review the user profiles stored in database 223 of FIG. 2 to determine the familiarity and level of knowledge for both parents and identify which parent has been designated the subject matter expert for the duplicate message. So, for a message related to attendance issues, the husband has been designated the subject matter expert and attendance related message would be delivered to the husband and not to the wife. For sports related messages, the wife has been designated as the subject matter expert and all duplicate sports related messages will be delivered to the wife and not to the husband.

Priority filter 596 can be configured to control which message platform is used for transmission and/or display of duplicate messages. This means that message recipients can determine the order of suppression for duplicate messages to ensure that messages are delivered to their most preferred message platform. For example, message recipients can configure the system so that if a duplicate message is detected, the message is delivered by the user configured message platform hierarchy. A message recipients may set their delivery preferences in order so that Facebook® posts>RSS feeds>Twitter® posts. With this preference hierarchy, if a Facebook® post is identical to a RSS feed post and a Twitter® post, then only the Facebook® posts will be visible to the message recipient and the remaining messages will be suppressed. If there are no identical Facebook® posts, but an RSS feed post is identical to a Twitter® post, then the RSS feed will be visible but the Twitter® post will be suppressed.

Length filter 597 can be used to determine which of the duplicate messages should be deleted. For example, if an email and a text message have been flagged as duplicate messages, length filter 597 can be used to eliminate the shorter or the longer of the two messages, based on message recipient preferences or system preferences. Where the longer message is preferred, then the shorter message will be eliminated and not delivered. Similarly, when the shorter message is preferred, the longer message will not be delivered or displayed.

Existing event filter 598, can be configured to review the message recipient's calendar of events and search for matching events. For example, if a message regarding a football game has been previously sent, and the message recipient has entered the football game into the calendar application on their cell phone, then system 100 can compare the text of new message announcing the football game to the calendar events on the cell phone. If the message recipient has already added the football game to their calendar, the existing event filter 598 would eliminate the duplicate message.

Content filter 599 includes a user configurable “confidence interval” for content matching. So, for a given message recipient, the confidence interval may be set to trigger at 85% meaning that if 85% of the content of multiple messages is identical, the message will be flagged as a duplicate message subject to delivery screening. Another message recipient may have a higher or lower confidence level setting (e.g., 75% or 90%) and the identification of potentially duplicate messages will vary accordingly. Once a group of messages have been identified as duplicates, system 100 can eliminate all but one of the duplicate messages to prevent delivery of the duplicates.

Duplicate message filters 590 depicted in FIG. 5A may be used alone or in various combinations to enhance the probability of identifying and screening out duplicate messages prior to delivery. Additionally, most of duplicate message filters 590 are user configurable to allow for maximum flexibility in the application of redundancy filters 590. Those skilled in the art will recognize that the message delivery scheduling functions, coupled with the redundancy filtering functions, will enable a message recipient to more effectively and efficiently control the flow of messages that are received.

Further, in the case of multiple duplicate messages, system 100 can be configured to deliver the message via the most efficient and cost effective manner. For example, many organizations have to pay a fee for delivering messages via certain communication platforms. If two options are available, system 100 will choose the least expensive option by default, if no other message delivery parameters dictate otherwise.

In addition, message recipients can change the suppression configuration for duplicate messages on a global basis as well as a filter-by-filter basis. User interface 224 of FIG. 2 comprises a duplicate message configuration page with a user interface and each message recipient can determine which messages and which delivery platforms they want suppressed. For example, message recipients can select or unselect different categories of messages for suppressions. Some examples of categories for messages in an educational environment are attendance messages, emergency messages, and newsletters. In at least one preferred embodiment of the present invention, the parent organization is able to override the message recipient's preferences for duplicate message suppression.

In addition to messages that are sent directly to individual message recipients, the use of filters 590 can also enhance other communications as well. For example, multiple people from an organization post the same or similar content to a common location (e.g., a school's Facebook® page, Twitter® feed, or news “mashup”), creating duplicate messages at the location. System 100 can be configured to examine each new message or posting and check for duplicate posts for the organization's Facebook® account or the Twitter® account. If the message has already been posted, then the duplicate message will not be posted. In the case of a news mashup, where there has been an updated post, system 100 will make a copy of the posts and import it into database 223. Then, system 100 will republish those posts in the news mashup of individual consumers who are using a mobile app. In some embodiments, the administrator can use a single interface via mobile app or via web access to system 100 when they type up a message and then select to post the messages to different platforms such as a Facebook® channel and a Twitter® platform.

In at least one embodiment of the present invention, system 100 provides an option to capability to retract message after it has been scheduled for transmission. User interface 224 will present the message originator with a user interface element (e.g., a button or other control) where the message originator can elect to identify and retract a previously transmitted message. In some circumstances the principal may change his or her mind about sending the message. This is accomplished by waiting for a predetermined but user configurable period of time before actually transmitting messages from system 100. In other words, message designated for delivery to message recipients are stored in message queue 227 for some period of time prior to being transmitted. At any time prior to transmission, the message originator can “retract” the message that will delete the message from message queue 227.

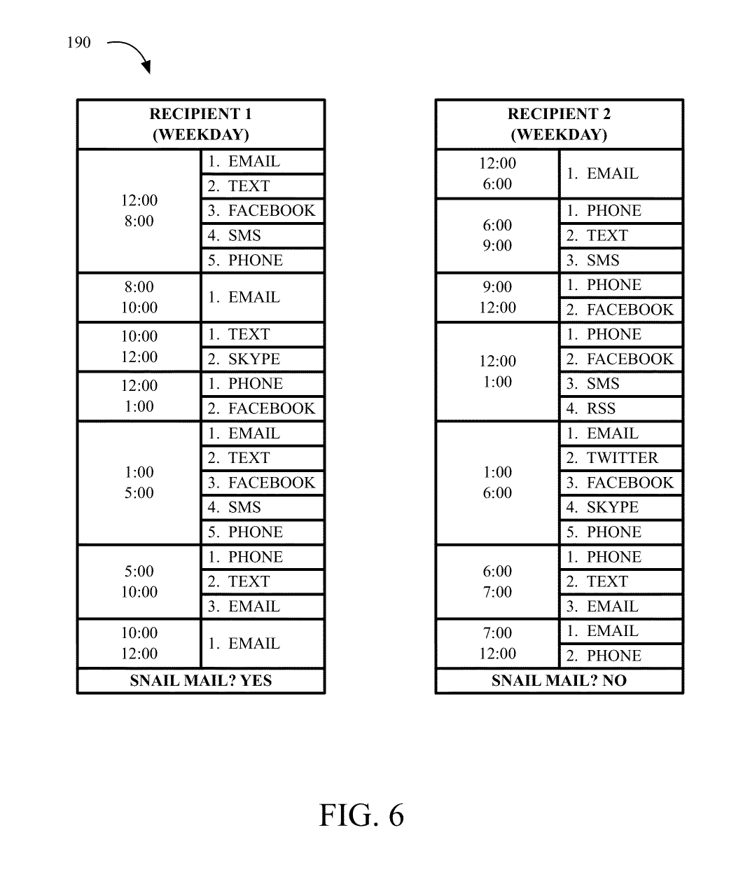

Referring now to FIG. 6, a block diagram illustrating the message receipt options for recipient 1 and recipient 2 are depicted. As shown in FIG. 6, each recipient may specify various time frames for receiving messages as well as the preferred message or communication platform for receiving message for each specific time frame. Once again, the message originator may specify an “emergency” condition and override the message recipient's message receipt preferences.

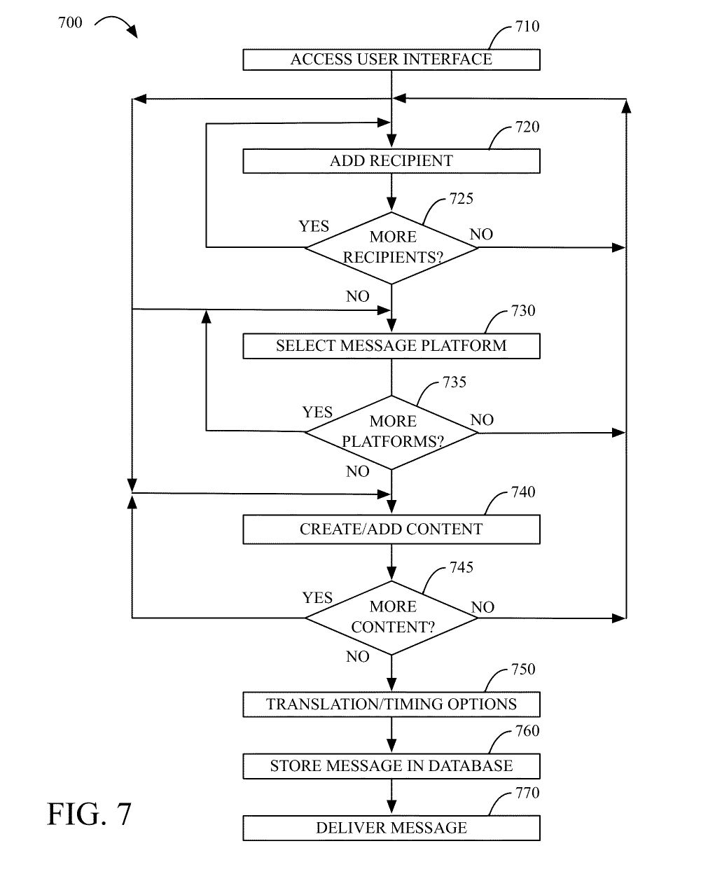

Referring now to FIG. 7, a flowchart 700 for creation of a message by a message originator for delivery to one or more message recipients is depicted. As shown in FIG. 7, a message originator will access a user interface (step 710) to create a message for delivery to one or more message recipients. The user interface may be user interface 224 of FIG. 2 or a user interface accessed via mobile communication device 190 of FIG. 1 (e.g., an “app” on a smart phone). The message originator can specify one or more recipients for the message (step 720), repeating as necessary (step 725=“YES”) until all intended message recipients have been identified (step 725=“NO”).

With the intended message recipients identified, the message originator will select one or more message delivery platforms (e.g., email, text message, telephone, snail mail, etc.) for transmitting the message to the recipients (step 730). As shown in FIG. 7, the message originator may specify as many message delivery platforms as desired (step 735=“YES”) until all desired message platforms have been identified (step 735=“NO”).

With the other message parameters identified, the message originator may create or add content (e.g., text, audio, graphic attachments, etc.) for inclusion with the message (step 740) and continue adding or creating content (step 745 “YES”) until all desired content has been added and/or created (step 745=“NO”).

It should be noted that even though a message originator includes certain content in a message (e.g., audio-video content), some intended message recipients may not have devices capable of receiving the content included in the message created by the message originator. However, this is not a problem because the message originator does not need to know about the capabilities of the message recipient's devices. Messaging mechanism 225 of FIG. 2 will access database 223 of FIG. 2 and ascertain what message platforms are appropriate for each designated message recipient to ensure that only compatible message content is delivered to each message recipient. The most “content-rich” option will be selected for each message recipient.

In addition, the message originator may also specify message translation options and a time frame for message delivery (step 750) that, in certain circumstances, may include an “emergency” designation that would override the message recipient's message receipt preferences to ensure that emergency messages are delivered immediately. After all of the relevant and desired message parameters have been specified, the message will be stored in database 223 of FIG. 2 (step 760) for later delivery of the message (step 770) by messaging mechanism 225 of FIG. 2.

Additionally, in at least some preferred embodiments of the present invention, the time frame and priorities for message delivery options may be automatically ascertained and assigned by reference to a one or more identification factors. For example, any message sent to a group of recipients identified as “Teachers” may be automatically scheduled for delivery at the beginning of the school day and sent via email to the email address for each of the teachers included in the “Teacher” group.

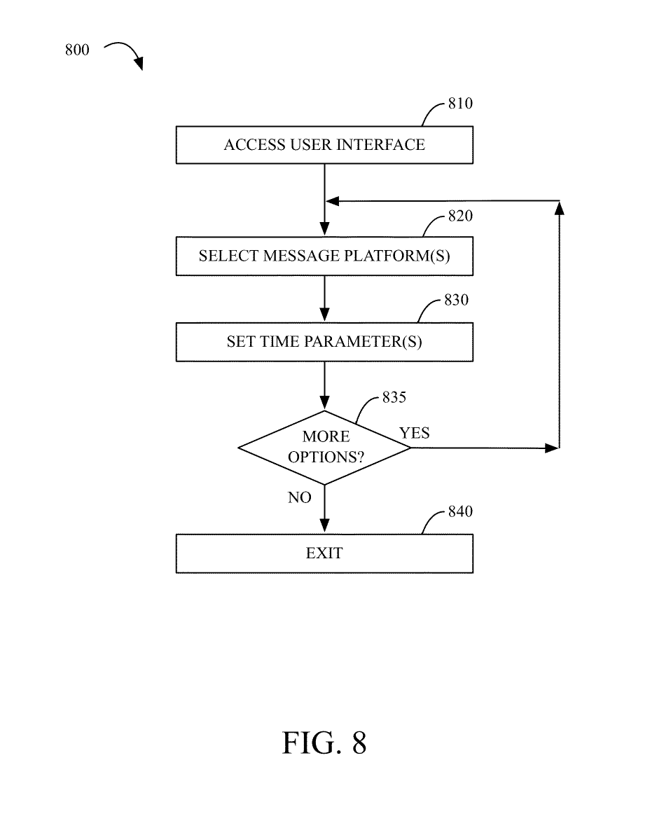

Referring now to FIG. 8, an overall process and method 800 for setting message recipient preferences for receiving messages in accordance with a preferred embodiment of the present invention is shown. As shown in FIG. 8, a message recipient will access a user interface (step 810) to specify their preferred message receipt options. The user interface may be user interface 224 of FIG. 2 or a user interface accessed via mobile communication device 190 of FIG. 1 (e.g., an “app” on a smart phone). The message recipient will select one or more message delivery platforms (e.g., email, text message, telephone, snail mail, etc.) for receiving messages from message originators (step 820) and, if desired, specify delivery time parameters associated with each message delivery platform (step 830), repeating as necessary (step 835=“YES”) until all intended message recipients have been identified (step 835=“NO”) at which point the message recipient will exit the message receipt preferences portion of the user interface (step 840).

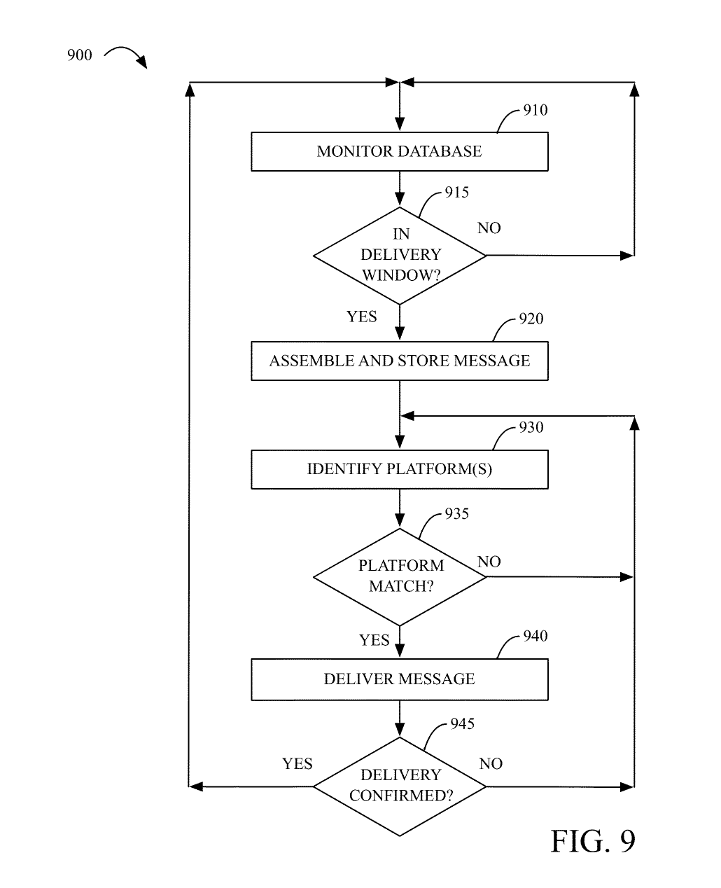

Referring now to FIG. 9, a flowchart for a method 900 for delivery of messages in accordance with a preferred embodiment of the present invention is depicted. As shown in FIG. 9, messaging mechanism 225 of FIG. 2 will continually monitor database 223 of FIG. 2 (step 910) to locate any message that are in the appropriate time window for message delivery. If no messages are in the delivery window (step 915=“NO”), then the database monitoring (step 910) will continue. If one or more messages are in the delivery window (step 915=“YES”), messaging mechanism 225 of FIG. 2 will extract the message components (e.g., textual content, audio-video content, etc.) from database 223 and assemble the message and then move the message-to-message queue 227 of FIG. 2 (step 920). As previously mentioned, messaging mechanism 225 of FIG. 2 will access database 223 of FIG. 2 and ascertain what message platforms are appropriate for each designated message recipient (step 930) to ensure that only compatible message content is delivered to each message recipient.

By identifying the message receipt capabilities of each intended message recipient, as well as the delivery options specified by the message originator, messaging mechanism 225 of FIG. 2 would identify the most appropriate message content for each message recipient. If the content specified by the message originator matches the message recipient's message receipt capabilities (step 935=“YES”), then the message will be delivered (step 940). If the most preferred message delivery platform specified by the message originator includes content that is not deliverable due to limitations on the message recipient's message receipt capabilities (step 935=“NO”), then the next most preferred message delivery platform will be identified. This process will continue until a match is found that the most “content-rich” option will be selected for each message recipient.

Another factor for matching of message content may be time dependent. For example, if a message originator has specified a message for delivery on a certain day, the message may be delivered via a certain message delivery platform to one message recipient at a first time and the identical message may be delivered to a second message recipient at a second time because each message recipient has specified different preferred time frames for their messages. In this fashion, even though a message originator created a single message, each message recipient may receive a different version of the message, at a different time, based on their device capabilities and their message receipt preferences.

Once a message has been delivered, system 100 will monitor any communication received back from the message recipient(s) to ascertain whether or not the message has been successfully delivered. The confirmation may take many forms, depending on the message delivery platform specified. For example, if the message is to be delivered via telephone, a constant busy signal would be interpreted to mean that the message delivery did not take place as intended (step 945=“NO”). System 100 would continue to try for the period of time specified by the message originator but the telephone call may never take place.

In this instance, alternative message delivery platforms may be identified and selected (step 930) so as to ensure that the message is ultimately delivered. Similarly, if a message recipient has identified email as their most preferred message receipt option, that will be the initial message delivery platform. However, if the email message is rejected for any reason (e.g., the message recipient's email server is off-line), then system 100 will receive a “bounce back” notification, indicating that the message was not successfully delivered (step 945=“NO”). In that case, a secondary or tertiary delivery method may be identified (step 920) and used (e.g., sending a text message or making an automated telephone call) until such time as the message is successfully delivered (step 945=“YES”). If all message delivery options have been exhausted and the message still has not been successfully delivery, then system 100 will generate an error message to alert the message originator of the message delivery failure.

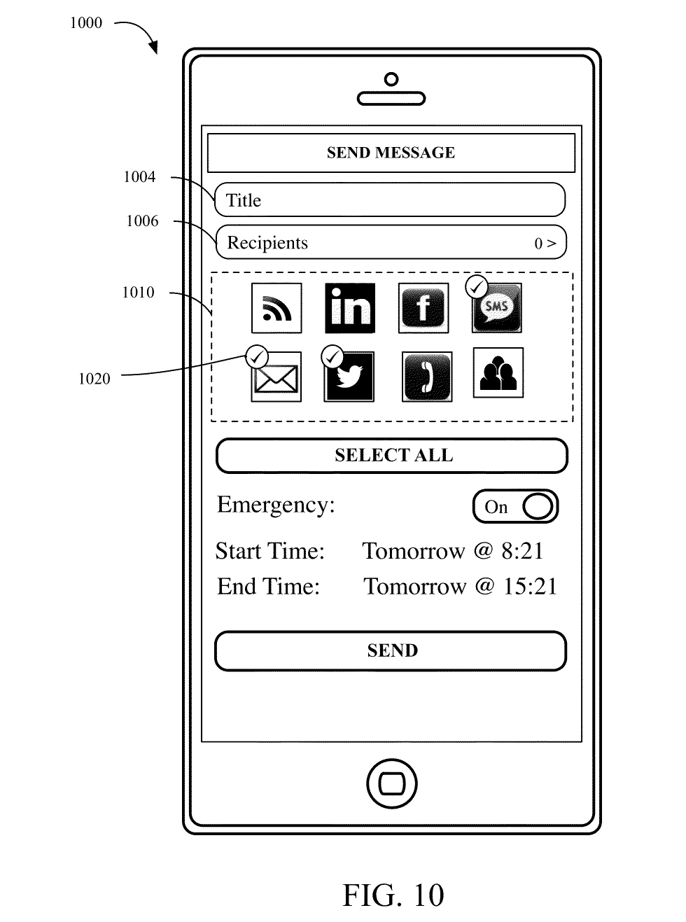

Referring now to FIG. 10, a mobile app user interface 1000 for preparing messages for delivery by optimized message creation and delivery 100 of FIG. 1 in accordance with a preferred exemplary embodiment of the present invention is depicted. User interface 1000 represents a typical user interface that might be displayed by mobile communication device 910 of FIG. 1. As shown in FIG. 10, a message originator may access the “SEND MESSAGE” portion or user interface 1000 and prepare a message for delivery to one or more recipients using a variety of message delivery platforms. The message originator may indicate a desired title 1004 or subject matter for the message and also create a message recipient list 1006 by selecting one or more message recipients who will be the recipients of the message. As previously explained, a message recipient may be a single individual or a previously identified group of individuals.

As shown in FIG. 10, user interface 1000 includes a plurality of icons 1010, with each icon 1010 representing a different communication or message delivery platform that can be specified for sending messages to one or more recipients. Badge 1020 is an icon that provides visual feedback to the message originator to identify which message delivery platform(s) have been selected. In this case, the message originator has identified email, Twitter® and SMS text messaging as the desired message delivery platforms for the message. The message originator may select each icon 1010 individually, or simultaneously select all icons 1010 by clicking on the “SELECT ALL” button in user interface 1000. Each selected icon 1010 will have a badge 1020 affixed to the icon 1010, indicating that message platform will be used to transmit the message from the message originator to the message recipient.

Additionally, the message originator may designate a message as an “Emergency” message, if desired. If a message has been designated as an “Emergency” message, then the message recipient's default message receipt preferences may be overridden and the message will be delivered immediately and to all specified devices, even if this delivery protocol would be in conflict with message receipt preferences established by the message recipient(s). Further, in the most preferred embodiments of the present invention, the message originator will also specify the start time and end time for message delivery. This will establish a delivery window and messaging mechanism 225 of FIG. 1 will continue to attempt delivery of the message during the time frame established by the window.

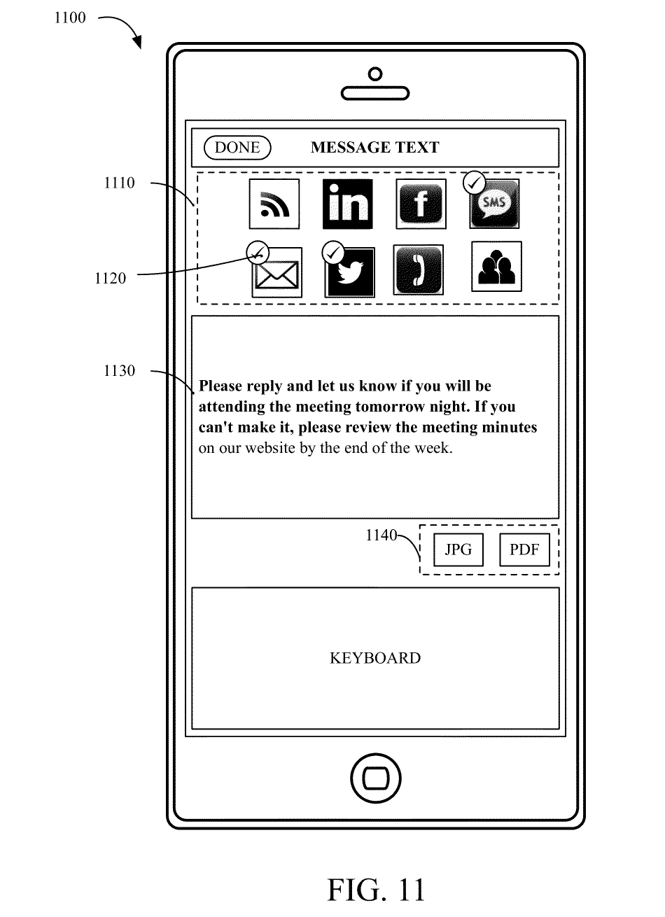

Referring now to FIG. 11, a user interface 1100 for adding content to messages for delivery by optimized message creation and delivery 100 of FIG. 1 in accordance with a preferred exemplary embodiment of the present invention is depicted. User interface 1100 represents a typical user interface that might be displayed by mobile communication device 910 of FIG. 1. As shown in FIG. 11, user interface 1100 includes a plurality of icons 1010, with each icon 1010 representing a different communication or message delivery platform that can be specified for sending messages to one or more recipients. Badge 1020 is an icon that provides visual feedback to the message originator to identify which message delivery platform(s) have been selected. In this case, the message originator has identified email, Twitter® and SMS text messaging as the desired message delivery platforms and the message text content is displayed in text box 1130. In addition, the message originator has also included two attachments to the message, as indicated by attachment icons 1140. The message originator may add any type of attachments to the message that are supported by the operating system and application software associated with mobile communication device 190 of FIG. 1.

It should be noted that the message text 1130 may be automatically truncated or adjusted as necessary to comply with the text limits of the selected delivery platforms. For example, the email option will may allow virtually unlimited textual content to be included in the email. However, Twitter® has a 140 character limit for messages and some SMS text messaging platforms also have a character limitation (e.g., 160 characters). In these cases, the textual content may be programmatically truncated or otherwise manipulated to comply with the limitations inherent in the message delivery platform.

In addition, in at least some preferred embodiments of the present invention, a visual indicator may be displayed to the user as the textual content is entered, alerting the message originator that some of the textual content may not be delivered. This will allow the message originator to adjust the textual content as necessary. For example, in FIG. 11, the textual information that will be included in the character limited delivery platforms is shown as highlighted text, indicating to the message originator that the non-highlighted text will not be sent to those message recipients who have specified SMS or Twitter®. Additionally, certain message recipients may not have the capability to receive attachment on their mobile communication device and, accordingly, they will not receive the attachments. Alternatively, a color may be used to highlight one or more of message delivery platform icons 1010, if the length of the textual content is incompatible with one or more of the selected message delivery platforms.

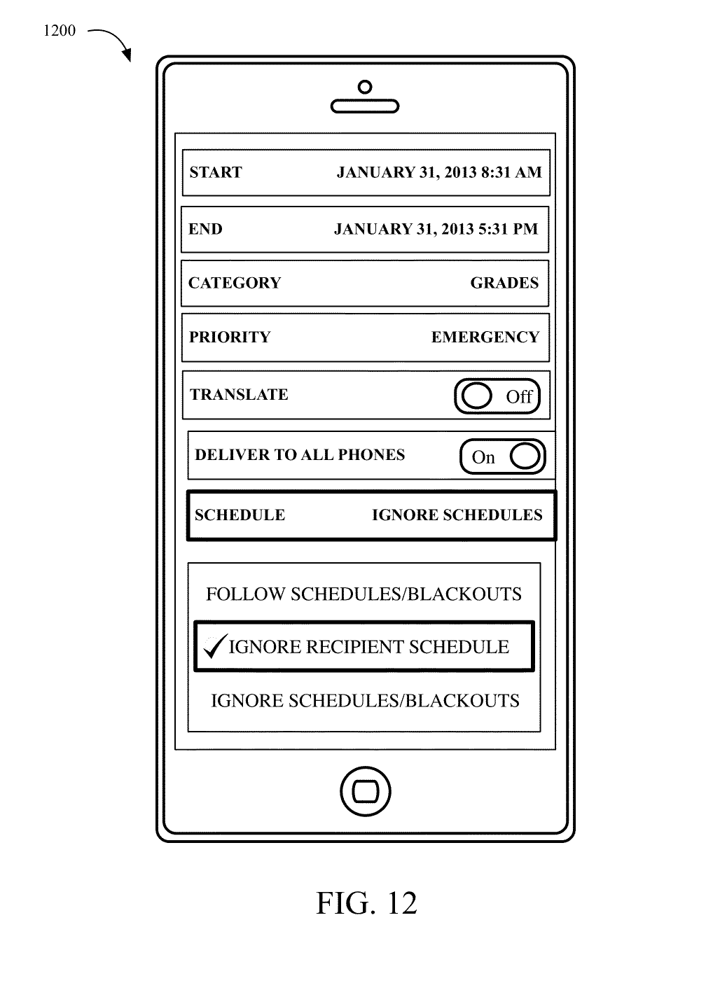

Referring now to FIG. 12, a user interface 1200 for specifying additional message parameters for messages to be delivered by optimized message creation and delivery 100 of FIG. 1 in accordance with a preferred exemplary embodiment of the present invention is depicted. User interface 1200 represents a typical user interface that might be displayed by mobile communication device 910 of FIG. 1. As shown in FIG. 12, the start time and end time for delivering the message are displayed. Additional information about the message and the delivery options are specified. For example, in this case, a message category has been included and the message originator has decided to have the message delivered to all phones for all message recipients. This means that the message will be delivered to all phones listed in each message recipient's user profile. The translation option has also been activated. This means that that message content will be translated from the original language into the target language specified in each message recipient's user profile. Finally, since the message originator has designated the message as an “EMERGENCY” message, the message recipient's message receipt preferences will be overridden.

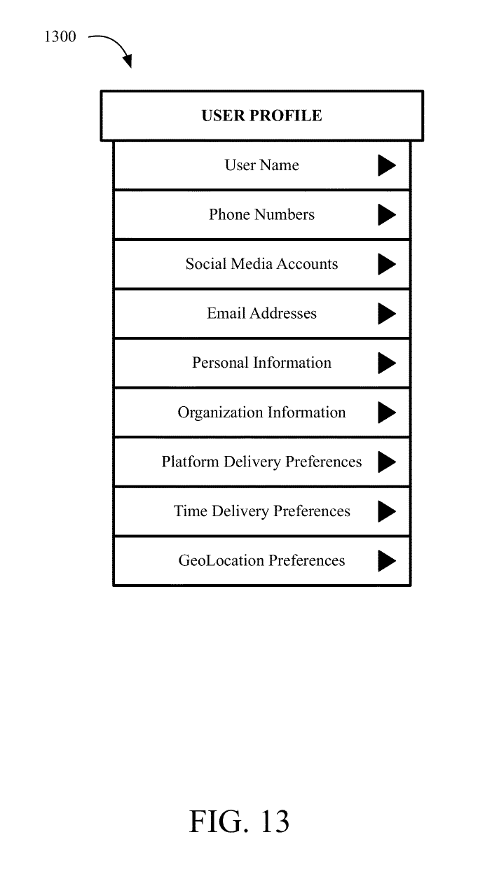

Referring now to FIG. 13, a user interface 1300 for specifying message recipient preferences for messages to be delivered by optimized message creation and delivery 100 of FIG. 1 in accordance with a preferred exemplary embodiment of the present invention is depicted. User interface 1300 represents a portion of user interface 224 of FIG. 2 as might be displayed on desktop computer 170 and/or laptop computer 180 of FIG. 1. As shown in FIG. 13, each message recipient will have a user profile that specifies the salient information relevant for delivering messages for that message recipient. The message recipient can access their user profile and enter or provide the information necessary to allow system 100 to deliver messages to the message recipient. User interface 1300 provides a summary of all currently available message platform delivery options for the message recipient.

For example, the message recipient's phone numbers, email addresses, social media identifiers, physical address, etc. can all be stored and updated in the message recipient's user profile. By selecting one or more of the options shown in FIG. 13, the message recipient can establish each preference and element. Whenever a message is to be delivered to a message recipient, system 100 will use the user profile information to send the message to the message recipient. Additionally, the message recipient can selectively enable or disable each message delivery platform option and also specify the time frame for message delivery via each message delivery platform.

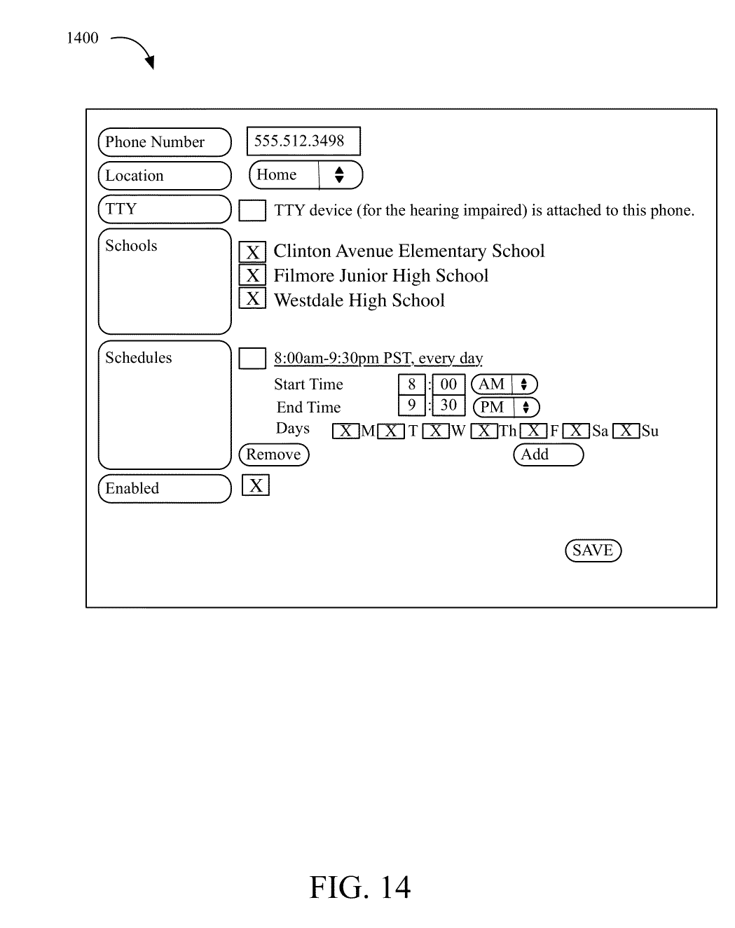

Referring now to FIG. 14, a user interface 1400 for adding or modifying one or more message delivery platforms for messages to be delivered by optimized message creation and delivery 100 of FIG. 1 in accordance with a preferred exemplary embodiment of the present invention is depicted. User interface 1400 represents a portion of user interface 224 of FIG. 2 as might be displayed on desktop computer 170 and/or laptop computer 180 of FIG. 1. As shown in FIG. 14, each message recipient can provide salient details for each message delivery platform. In this case, the message recipient is specifying the message delivery options for the home telephone number associated with the message recipient. The message recipient has selected a number of schools in the area where her children are attending classes. By enabling message delivery from these schools, relevant messages from these schools will be transmitted to the specified phone number at the specified times. The message recipient could also opt to add in a cellular phone number, a work phone number, etc. and the message delivery preferences for each phone number can be specified to match the message recipient's desired options.

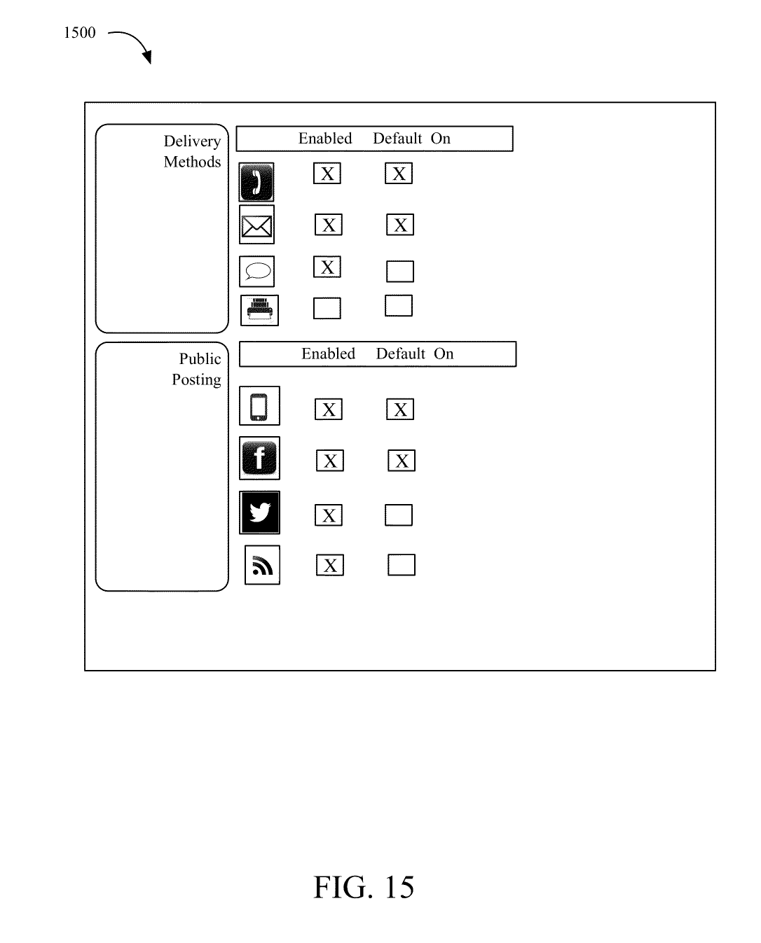

Referring now to FIG. 15, a user interface 1500 for identifying message parameters for messages to be delivered by optimized message creation and delivery 100 of FIG. 1 in accordance with a preferred exemplary embodiment of the present invention is depicted. User interface 1500 represents a portion of user interface 224 of FIG. 2 as might be displayed on desktop computer 170 and/or laptop computer 180 of FIG. 1. As shown in FIG. 15, an administrator or supervisor may elect to enable or disable certain message platform delivery options for the users of system 100. Since the most preferred embodiments of the present invention are deployed in multi-tier, hierarchical organizations such as schools, controlling the delivery options for message originators may be a desirable activity.

For example, the administrator at the school district level may opt to disable message delivery via printer output, in order to conserve resources. Similarly, the administrator may elect to limit the public posting options for message delivery. At each subsequent level (e.g., each individual school), the local administrator may be authorized to further restrict the delivery platform options, as necessary or desired. The effect of these choices will be “inherited”: by and reflected in the user interface for each message originator.

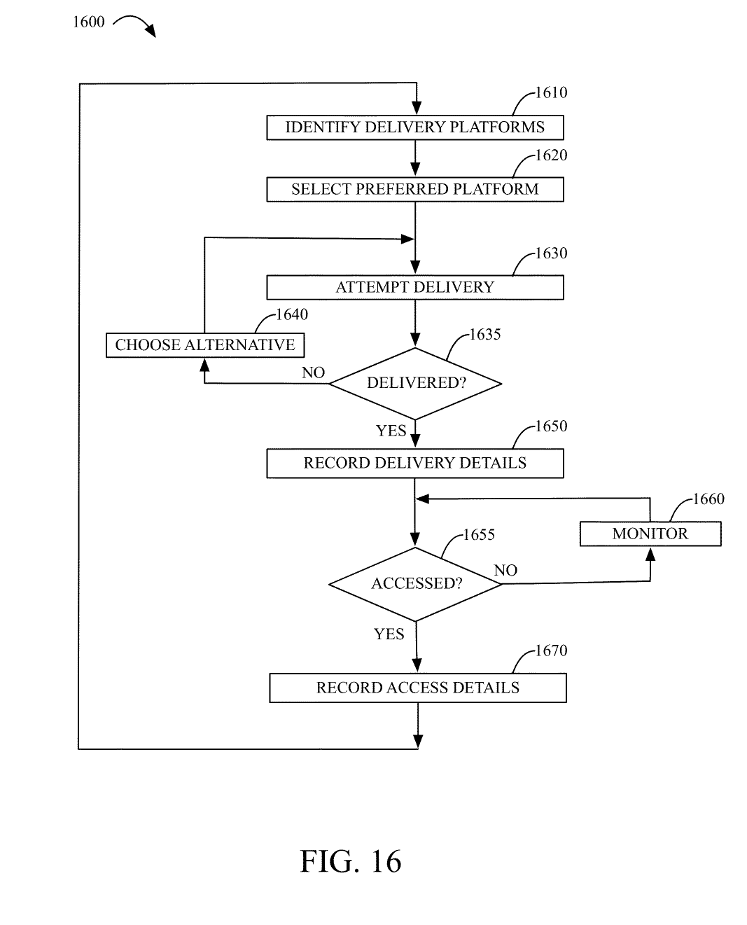

Referring now to FIG. 16, a method 16 for optimized message creation and delivery in accordance with an alternative preferred embodiment of the present invention is depicted. As shown in FIG. 16, the first step will be to identify the potential message delivery platforms for the intended message recipient (step 1610). For example, a given message recipient may have a home phone (e.g., land line), a cell phone, an email address, etc. associated with their account while another message recipient may not have a home phone. Additionally, using a cell phone as an example, the message recipient may be able to receive voice messages, text message, twitter messages, etc. all on the cell phone. This is important because one important feature of the invention is the ability to treat each possible delivery method as a separate messaging platform and, to the extent possible, track the delivery of the message to each separate messaging platform so as to stop sending the message as soon as the system can verify that the message recipient has accessed the message. In this fashion, the delivery of duplicate messages can be reduced or eliminated.

Next, based on the message delivery preferences of the message originator and/or the message recipient, the most preferred message delivery platform will be selected and the message will be formatted for the selected message delivery platform (step 1620) and the message will be delivered (step 1630).

If the message is successfully delivered via the selected message delivery platform (step 1635=“YES”), then the message delivery details (e.g., time, date, etc.) will be recorded (step 1650). However, if the message is not successfully delivered (step 1635=“NO”), then the next most preferred message delivery platform will be selected (step 1640) and delivery will be attempted via the message delivery platform (step 1630). This delivery cycle will continue until the message has been successfully delivered. In some instances, after all of the delivery options have been exhausted, and if the message has not been successfully delivered, the system may return an error message to the message originator to identify the failed message delivery cycle.

After successful delivery, the system will monitor the message recipient's account to determine whether or not the message recipient has accessed the delivered message (step 1655). If the message recipient has accessed the message (step 1655=“YES”), then the details (e.g., time, date, etc.) of the accessed message will be recorded (step 1670). However, if the message has not been accessed (step 1655=“NO”), then the system will continue to monitor the message recipient's account (step 1660) until the message is accessed or until the system determines that a failure has occurred and the system may return an error message to the message originator to identify the failed access cycle. Method 1600 can be repeated for multiple messages and multiple message originators and message recipients. As previously explained, once the message has been received and accessed by the message recipient, further message deliveries of the same message will not take place, thereby reducing or eliminating the potential of a message being sent to the same message recipient multiple times.

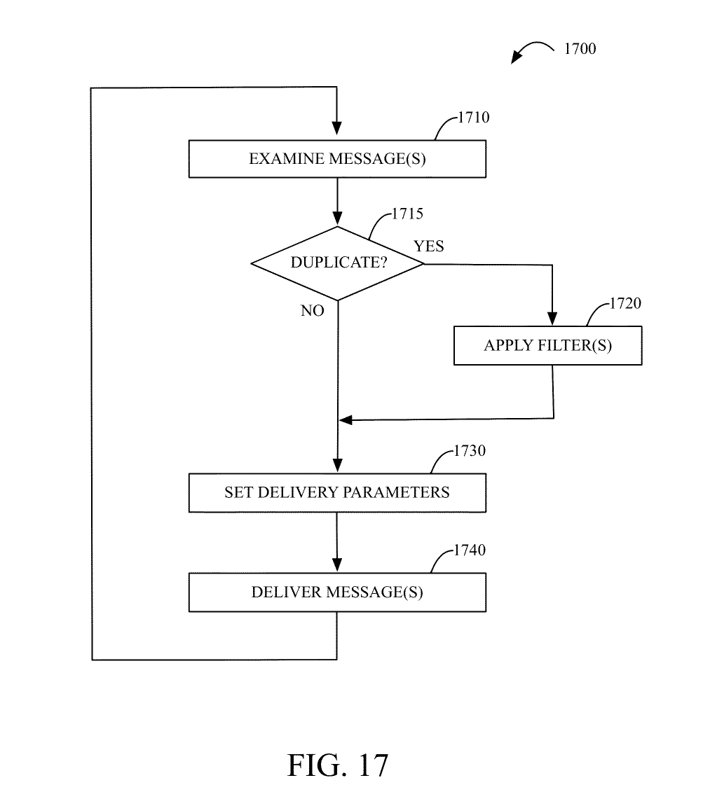

Referring now to FIG. 17, a method 1700 for reducing or eliminating duplicate messages for optimized message creation and delivery in accordance with an alternative preferred embodiment of the present invention is depicted. As shown in FIG. 17, the first step is to examine messages to determine whether or not there is a duplicate message (step 1710). Any of the methods described herein may be used to detect and identify duplicate messages. If the message is a duplicate message (step 1715=“YES”) then the selected duplication filters are from FIG. 5A can be applied so as to reduce or eliminate the duplication (step 1720).

With the appropriate filters applied, the appropriate message delivery parameters can be used to further ascertain and quantify the correct timing window and messaging platform for message delivery (step 1730) and the message can be delivered to the intended message recipient(s) (step 1740) and the process repeated for additional messages.

As will be appreciated by one skilled in the art, aspects of the computer-based system for providing optimized message creation and delivery disclosed herein may be embodied as a system, method or computer program product. Accordingly, aspects of the computer-based system for providing optimized message creation and delivery may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the computer-based system for providing optimized message creation and delivery may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the computer-based system for providing optimized message creation and delivery may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

From the foregoing description, it should be appreciated that computer-based system 100 and method for customized messaging disclosed herein presents significant benefits that would be apparent to one skilled in the art. Furthermore, while multiple embodiments have been presented in the foregoing description, it should be appreciated that a vast number of variations in the embodiments exist. Lastly, it should be appreciated that these embodiments are preferred exemplary embodiments only and are not intended to limit the scope, applicability, or configuration of the invention in any way. Rather, the foregoing detailed description provides those skilled in the art with a convenient road map for implementing a preferred exemplary embodiment of the invention, it being understood that various changes may be made in the function and arrangement of elements described in the exemplary preferred embodiment without departing from the spirit and scope of the invention as set forth in the appended claims.

1. A computer-based system for providing optimized message creation and delivery comprising:
at least one processor;
at least one memory coupled to the at least one processor;
a database residing in the memory;
a messaging mechanism residing in the memory; and
at least one message scheduled to be delivered to at least one message recipient in accordance with a delivery schedule, wherein the delivery schedule is determined by identifying:
at least one preferred message platform for receiving the message selected by the at least one message recipient;
a priority for receiving the message content based on the preferred message platform selected by the at least one message recipient; and
a preferred time frame for receiving the message established by the at least one message recipient.

2. The computer-based system of claim 1 wherein the at least one message recipient comprises a plurality of message recipients and wherein the delivery schedule comprises a plurality of unique delivery schedules, wherein each of the plurality of delivery schedules is associated with one of the plurality of message recipients.

3. The computer-based system of claim 1 further comprising a user interface, wherein a message originator interacts with the user interface to:
identify the at least one message recipient; and
create or modify the message; and
wherein the at least one message recipient interacts with the user interface to:
identify at least one preferred message platform for receiving the message;
identify a priority for receiving the message based on the preferred message platform; and
identify a preferred time frame for receiving the message.

4. The computer-based system of claim 1 wherein the database comprises a plurality of message recipient messaging preferences for each of the plurality of message recipients and wherein the plurality of message recipient messaging preferences comprises:
at least one preferred message platform for receiving the message;
a priority for receiving the message based on the preferred message platform; and
a preferred time frame for receiving the message.

5. The computer-based system of claim 1 further comprising a message queue residing in the memory, the message queue containing a plurality of messages and wherein each of the plurality of messages is delivered in accordance with the delivery schedule.

6. The computer-based system of claim 1 further comprising a security mechanism residing in the memory, the security mechanism being configured to provide different levels of security for different message recipients and message originators.

7. The computer-based system of claim 1 wherein the at least one message comprises a plurality of content, the plurality of content being selected from the group consisting of textual content, image content, audio content, and hyperlink content.

8. The computer-based system of claim 1 wherein the at least one preferred message platform comprises a messaging platform selected from the group consisting of Skype®, Twitter®, Facebook®, Tumblr®, Instagram®, Google Chat®, and Google+®.

9. The computer-based system of claim 1 wherein the at least one preferred message platform comprises a plurality of messaging platforms and wherein each of the plurality of messaging platforms has an associated priority and an associated delivery schedule that are used to derive the delivery schedule.

10. The computer-based system of claim 1 wherein at least one message recipient comprises a plurality of message recipients and wherein the at least one message is delivered to each of the plurality of message recipients on a different delivery schedule.

11. A method for providing optimized message creation and delivery comprising the steps of:
accessing a user interface;
identifying at least one message recipient;
selecting at least one message platform for delivering a message to the message recipient via the user interface;
creating the message via the user interface, the message comprising message content; and
creating a delivery schedule for delivering the message content to the at least one message recipient based on a plurality of message recipient preferences via the user interface, the delivery schedule comprising:
at least one preferred message platform for receiving the message content selected by the message recipient;
a priority for receiving the message content based on the preferred message platform selected by the message recipient; and
a preferred time frame for receiving the message content established by the message recipient.

12. The method of claim 11 wherein the step of accessing a user interface comprises the step of accessing at least one of a web browser user interface or a native application on a mobile communication device.

13. The method of claim 11 further comprising the steps of:
creating a delivery schedule for delivering the message content to the at least one message recipient based on a plurality of message recipient preferences and a plurality of message originator preferences, the delivery schedule comprising:
at least one preferred message platform for receiving the message content selected by the message recipient;
a priority for receiving the message content based on the preferred message platform selected by the message recipient;
a preferred time frame for receiving the message content established by the message recipient;
at least one preferred message platform for sending the message content selected by the message originator;
a priority for sending the message content based on the preferred message platform selected by the message originator; and
a preferred time frame for sending the message content established by the message originator; and
programmatically using a messaging mechanism to determine an optimal message platform and an optimal time frame for delivering the message to the message recipient based on both the message originator preferences and message recipient preferences.

14. The method of claim 11 wherein the step of selecting at least one message platform for delivering a message to the message recipient comprises the step of selecting a plurality of message platforms.

15. The method of claim 11 wherein the step of creating a delivery schedule for delivering the message content to the at least one message recipient based on a plurality of message recipient preferences comprises the step of creating a delivery schedule for delivering the message content to a plurality of message recipients based on a plurality of message recipient preferences associated with each of the plurality of message recipients and wherein each of the plurality of message recipient preferences comprises:
at least one preferred message platform for receiving the message content selected by each of the plurality of message recipients;
a priority for receiving the message content based on the preferred message platform selected by each of the plurality of message recipients; and
a preferred time frame for receiving the message content established by each of the plurality of message recipients.

16. The method of claim 11 further comprising the step of overriding the delivery schedule and sending an emergency message to the message recipient using all communication platforms.

17. The method of claim 11 wherein the user interface displays a plurality of icons wherein each of the icons represents a different messaging platform that can be selected for delivering the message to the message recipient and wherein each of the plurality of messaging platforms that has been selected for delivering the message displays a badge icon.

18. An article of manufacture comprising software stored on a tangible non-volatile computer readable storage medium, the software comprising a messaging mechanism, the messaging mechanism being configured to deliver at least one message to at least one message recipient in accordance with a delivery schedule, wherein the delivery schedule is determined by identifying:
at least one preferred message platform for receiving the message selected by the at least one message recipient;
a priority for receiving the message content based on the preferred message platform selected by the at least one message recipient; and
a preferred time frame for receiving the message established by the at least one message recipient.

19. The article of manufacture of claim 18 wherein the messaging mechanism is configured to display a user interface, the user interface displaying a plurality of icons wherein each of the icons represents a different messaging platform that can be selected for delivering the message to the message recipient and wherein each of the plurality of messaging platforms that has been selected for delivering the message displays a badge icon.

20. The article of manufacture of claim 18 wherein the messaging mechanism is configured to create the delivery schedule by identifying:
at least one preferred message platform for receiving the message content selected by the message recipient;
a priority for receiving the message content based on the preferred message platform selected by the message recipient;
a preferred time frame for receiving the message content established by the message recipient;
at least one preferred message platform for sending the message content selected by the message originator;
a priority for sending the message content based on the preferred message platform selected by the message originator; and
a preferred time frame for sending the message content established by the message originator; and
programmatically using a messaging mechanism to determine an optimal message platform and an optimal time frame for delivering the message to the message recipient based on both the message originator preferences and message recipient preferences.

21. A computer-based system for providing optimized message creation and delivery comprising:
at least one processor;
at least one memory coupled to the at least one processor;
a database residing in the memory;
a messaging mechanism residing in the memory;
a plurality of messages scheduled to be delivered to at least one message recipient in accordance with a delivery schedule; and
at least one duplication filter, the at least one duplication filter being configured to identify and reduce at least one duplicate message contained within the plurality of messages.

22. The computer-based system of claim 21 wherein the at least one duplication filter is selected from a group comprising:
a geolocation filter;
a temporal proximity filter;
a spatial/time filter;
an age filter;
a subject matter expert filter;
a priority filter;
a length filter;
an existing event filter; and
a content filter.

23. The computer-based system of claim 21 wherein the at least one duplication filter comprises:
a geolocation filter;
a temporal proximity filter;
a spatial/time filter;
an age filter;
a subject matter expert filter;
a priority filter;
a length filter;
an existing event filter; and
a content filter.

24. The computer-based system of claim 21 wherein the delivery schedule is determined by identifying:
at least one preferred message platform for receiving the message selected by the at least one message recipient;
a priority for receiving the message content based on the preferred message platform selected by the at least one message recipient; and
a preferred time frame for receiving the message established by the at least one message recipient.

25. The computer-based system of claim 21 wherein the at least one duplication filter comprises a plurality of duplication filters and wherein the plurality of messages scheduled to be delivered to at least one message recipient in accordance with a delivery schedule comprises a first set of messages selected from plurality of messages delivered to a first message recipient based on the application of the plurality of duplication filters and further comprising a second set of messages selected from the plurality of messages, the second set of messages being delivered to a second message recipient, the first set of messages and the second set of messages differing based on the application of the plurality of duplication filters.

26. The computer-based system of claim 25 wherein the plurality of duplication filters comprises:
a geolocation filter;
a temporal proximity filter;
a spatial/time filter;
an age filter;
a subject matter expert filter;
a priority filter;
a length filter;
an existing event filter; and
a content filter.

27. The computer-based system of claim 26 wherein the subject matter expert filter is configured to eliminate a message from the first set of messages or the second set of messages based on a pre-identified level of knowledge for the first message recipient and the second message recipient.

28. The computer-based system of claim 26 wherein the age filter is configured to prevent delivery of a message from the first set of messages or the second set of messages based at least one of the age of the first message recipient and the age of second message recipient.

29. The computer-based system of claim 26 wherein the geolocation filter is configured to suppress a duplicate message sent to a second person or a second device where the duplicate message is substantially the same as an original message sent to a first person or a first device and where the first person or the first device are within a user configurable distance from the second person or the second device.

30. The computer-based system of claim 26 wherein the plurality of duplication filters comprises:
a geolocation filter, the geolocation filter being configured to suppress a duplicate message sent to a second person or a second device where the duplicate message is substantially the same as an original message sent to a first person or a first device and where the first person or the first device are within a user configurable distance from the second person or the second device;
a temporal proximity filter, the temporal proximity filter being configured to suppress a duplicate message sent via a second delivery platform at approximately the same time as an original message sent via a first delivery platform;
a spatial/time filter, the spatial/time filter being configured to prevent delivery of a message from the first set of messages or the second set of messages based on a user-configurable time period;
an age filter, the age filter being configured to prevent delivery of a message from the first set of messages or the second set of messages based at least one of the age of the first message recipient and the age of second message recipient;
a subject matter expert filter, the subject matter expert filter being configured to eliminate a message from the first set of messages or the second set of messages based on a pre-identified level of knowledge for the first message recipient and the second message recipient;
a priority filter, the priority filter being configured to transmit a message to at least one of the first message recipient and the second message recipient via a user-configurable message delivery platform prioritization;
a length filter, the length filter being configured to suppress the delivery of one of a first message and a second message, the first message comprising:
a first message content; and
a first message length;
the second message comprising:
a second message content; and
a second message length; and
wherein the second message content is substantially similar to the first message content and wherein the first message length is not equal to the second message length;
an existing event filter, the existing event filter being configured to suppress the delivery of a message to a message recipient based on the existence of a calendar event; and
a content filter, the content filter being configured to suppress the delivery at least one message based on a confidence interval where the confidence interval is expressed as a percentage based on identifying similar content in a first message and a second message.

31. A method for providing optimized message creation and delivery comprising the steps of:
accessing a user interface;
identifying at least one message recipient;
selecting at least one message platform for delivering a plurality of messages to the at least one message recipient via the user interface;
creating a plurality of messages via the user interface wherein each of the plurality of messages comprises message content;
creating a delivery schedule for delivering each of the plurality of messages to the at least one message recipient based on a plurality of message recipient preferences via the user interface; and
applying at least one duplication filter to identify and eliminate at least one duplicate message from the plurality of messages.

32. The method of claim 31 wherein the at least one duplication filter is selected from a group comprising: a geolocation filter; a temporal proximity filter; a spatial/time filter; an age filter; a subject matter expert filter; a priority filter; a length filter; an existing event filter; and a content filter.

33. The method of claim 31 wherein the at least one duplication filter comprises a geolocation filter; a temporal proximity filter; a spatial/time filter; an age filter; a subject matter expert filter; a priority filter; a length filter; an existing event filter; and a content filter.

34. The method of claim 31 wherein the delivery schedule comprises:
at least one preferred message platform for receiving the message content selected by the message recipient;
a priority for receiving the message content based on the preferred message platform selected by the message recipient; and
a preferred time frame for receiving the message content established by the message recipient.

35. The method of claim 31 wherein the step of identifying at least one message recipient comprises the step of identifying a plurality of message recipients and wherein the step of applying at least one duplication filter to identify and eliminate at least one duplicate message from the plurality of messages comprises the step of applying a plurality of duplication filters to eliminate at least one duplicate message and further comprising the steps of:
delivering a first group of messages selected from the plurality of messages to a first message recipient based on the application of the plurality of duplication filters; and
delivering a second group of messages selected from the plurality of messages to a second message recipient based on the application of the plurality of duplication filters.

36. The method of claim 31 wherein the at least one duplication filter comprises a plurality of duplication filters and wherein the plurality of messages scheduled to be delivered to at least one message recipient in accordance with a delivery schedule comprises a first set of messages selected from plurality of messages delivered to a first message recipient based on the application of the plurality of duplication filters and further comprising a second set of messages selected from the plurality of messages, the second set of messages being delivered to a second message recipient, the first set of messages and the second set of messages differing based on the application of the plurality of duplication filters.

37. The method of claim 36 wherein the plurality of duplication filters comprises:
a geolocation filter;
a temporal proximity filter;
a spatial/time filter;
an age filter;
a subject matter expert filter;
a priority filter;
a length filter;
an existing event filter; and
a content filter.

38. The method of claim 36 wherein the subject matter expert filter is configured to eliminate a message from the first set of messages or the second set of messages based on a pre-identified level of knowledge for the first message recipient and the second message recipient.

39. The method of claim 36 wherein the age filter is configured to prevent delivery of a message from the first set of messages or the second set of messages based at least one of the age of the first message recipient and the age of second message recipient.

40. The method of claim 36 wherein the geolocation filter is configured to suppress a duplicate message sent to a second person or a second device where the duplicate message is substantially the same as an original message sent to a first person or a first device and where the first person or the first device are within a user configurable distance from the second person or the second device;

41. The method of claim 36 wherein the plurality of duplication filters comprises:
a geolocation filter, the geolocation filter being configured to suppress a duplicate message sent to a second person or a second device where the duplicate message is substantially the same as an original message sent to a first person or a first device and where the first person or the first device are within a user configurable distance from the second person or the second device;
a temporal proximity filter, the temporal proximity filter being configured to suppress a duplicate message sent via a second delivery platform at approximately the same time as an original message sent via a first delivery platform;
a spatial/time filter, the spatial/time filter being configured to prevent delivery of a message from the first set of messages or the second set of messages based on a user-configurable time period;
an age filter, the age filter being configured to prevent delivery of a message from the first set of messages or the second set of messages based at least one of the age of the first message recipient and the age of second message recipient;
a subject matter expert filter, the subject matter expert filter being configured to eliminate a message from the first set of messages or the second set of messages based on a pre-identified level of knowledge for the first message recipient and the second message recipient;
a priority filter, the priority filter being configured to transmit a message to at least one of the first message recipient and the second message recipient via a user-configurable message delivery platform prioritization;
a length filter, the length filter being configured to suppress the delivery of one of a first message and a second message, the first message comprising:
a first message content; and
a first message length;
the second message comprising:
a second message content; and
a second message length; and
wherein the second message content is substantially similar to the first message content and wherein the first message length is not equal to the second message length;
an existing event filter, the existing event filter being configured to suppress the delivery of a message to a message recipient based on the existence of a calendar event; and
a content filter, the content filter being configured to suppress the delivery at least one message based on a confidence interval where the confidence interval is expressed as a percentage based on identifying similar content in a first message and a second message.
